(19) United States
(12) Patent Application Publication
(10) Pub. No.: US 2016/0027112 A1
(43) Pub. Date: Jan. 28, 2016

(54) Broadband Orthogonal Resource Grouping

(71) Applicant: Rivada Networks, LLC, Colorado Springs, CO (US)

(72) Inventors: Clint SMITH, Warwick, NY (US); Samuel Smith, Warwick, NY (US); Declan Ganley, Galway (IE)

(21) Appl. No.: 14/807,975

(22) Filed: Jul. 24, 2015

Related U.S. Application Data
(60) Provisional application No. 62/028,446, filed on Jul. 24, 2014.

(51) Int. Cl. G06Q 40/04

(52) U.S. Cl. CPC G06Q 40/04

(57) ABSTRACT

A dynamic spectrum arbitrage (DSA) system includes components configured with processor-executable instructions to implement methods for dynamically managing the availability, allocation, access, and use of telecommunication resources, such as radio frequency (RF) spectrum resources, between participating networks. The components may also be configured to generate granular resource units that each identify an amount of a telecommunication resource that is offered for allocation and/or use by other networks with respect to an area or volume, and offer the resource units for purchase, lease, or trade, such as via a commodities exchange or a telecommunications commodity exchange (TCE) component. The resource units may be generated so that they use a universal standard to identify, quantify, measure, and represent the telecommunication resources and/or so that they identify the telecommunication resources in a standardized format and structure that facilitates comparing and valuating the resource units or their offered amounts of telecommunication resources.

### RELATED APPLICATIONS

This application claims the benefit of priority to U.S. Provisional Application No. 62/028,446, entitled “Broadband Orthogonal Resource Grouping” filed Jul. 24, 2014, the entire contents of which are hereby incorporated by reference.

### BACKGROUND

With the ever increasing use of wireless communication devices for accessing networks and downloading large files (e.g., video files), there is an increasing demand for radio frequency spectrum. Smart phone users complain about dropped calls, slow access to the Internet and similar problems which are due largely to too many devices trying to access finite RF bandwidth allocated to such services. Yet parts of the RF spectrum go largely unused due to the non-continuous and episodic employment of such voice-radio communication bands. As such, methods and solutions for dynamically allocating underutilized telecommunication resources (e.g., RF spectrum, etc.) of a first telecommunication network for access and use by wireless devices that subscribe to other networks will be beneficial to the telecommunication networks, service providers, and to the consumers of telecommunication services.

In addition, due to the variance, variety, and complexity of telecommunication resources (e.g., RF spectrum, etc.), it is often challenging to represent, express, or offer such resources in uniform quantities or units that investors and other participants can readily understand. It is also challenging to properly quantify, assess, or compare the relative economic values of these telecommunication resources. As such, improved methods and solutions for dynamically allocating telecommunication resources via well-defined, granular, discrete, standardized and/or fungible resource units will also be beneficial to the telecommunication networks, service providers, and to the consumers of telecommunication services.

### SUMMARY

The various embodiments include dynamic spectrum arbitrage (DSA) methods that include generating granular resource units that each identify an amount of a telecommunication resource that is offered for allocation and use by other networks with respect to an area or volume, and offering the resource units for purchase, lease, or trade on a commodities exchange. In an embodiment, generating the granular resource units includes generating resource units that use a universal standard to identify, quantify, measure, and represent the telecommunication resource. In a further embodiment, generating the granular resource units includes generating resource units that identify the telecommunication resource in a standardized format and structure.

In a further embodiment, generating the granular resource units includes generating resource units that include a common reference point that is suitable for use in comparing the granular resource units against other resource units. In a further embodiment, the method may include comparing two or more resource units that represent different resource offerings from different networks to determine the relative economic value of the offered amounts of telecommunication resource. In a further embodiment, generating the granular resource units includes generating resource units that define an amount of bandwidth in relation to a geographic area encompassing one cubic meter. In a further embodiment, generating the granular resource units includes generating resource units that may be combined to cover a well-defined area.

In a further embodiment, the method may include combining the resource units to cover an area that encompasses one of a highway portion, a bridge, a navigation path, a waterway portion, and air traffic corridor. In a further embodiment, the resource units are resource cubes that include an altitude dimension, the method further including combining the resource units to cover one or more floors of an office building. In a further embodiment, offering the resource units for purchase, lease, or trade on a commodities exchange includes grouping the resource units to form a polygon, and offering the group of resource units for purchase, lease, or trade on the commodities exchange.

Further embodiments include a server computing device that includes a processor configured with processor-executable instructions to perform operations including generating granular resource units that each identify an amount of a telecommunication resource that is offered for allocation and use by other networks with respect to an area or volume, and offering the resource units for purchase, lease, or trade on a commodities exchange. In an embodiment, the processor may be configured with processor-executable instructions to perform operations such that generating the granular resource units includes generating resource units that use a universal standard to identify, quantify, measure, and represent the telecommunication resource.

In a further embodiment, the processor may be configured with processor-executable instructions to perform operations such that generating the granular resource units includes generating resource units that identify the telecommunication resource in a standardized format and structure. In a further embodiment, the processor may be configured with processor-executable instructions to perform operations such that generating the granular resource units includes generating resource units that include a common reference point that is suitable for use in comparing the granular resource units against other resource units. In a further embodiment, the processor may be configured with processor-executable instructions to perform operations further including comparing two or more resource units that represent different resource offerings from different networks to determine the relative economic value of the offered amounts of telecommunication resource.

In a further embodiment, the processor may be configured with processor-executable instructions to perform operations such that generating the granular resource units includes generating resource units that define an amount of bandwidth in relation to a geographic area encompassing one cubic meter. In a further embodiment, the processor may be configured with processor-executable instructions to perform operations such that generating the granular resource units includes generating resource units that may be combined to cover a well-defined area. In a further embodiment, the processor may be configured with processor-executable instructions to perform operations further including combining the resource units to cover an area that encompasses one of a highway portion, a bridge, a navigation path, a waterway portion, and air traffic corridor. In a further embodiment, the processor may be configured with processor-executable instructions to perform operations such that the resource units are resource cubes that include an altitude dimension, the method further including combining the resource units to cover one or more floors of an office building. In a further embodiment, the processor may be configured with processor-executable instructions to perform operations such that offering the resource units for purchase, lease, or trade on a commodities exchange includes grouping the resource units to form a polygon, and offering the group of resource units for purchase, lease, or trade on the commodities exchange.

Further embodiments include a non-transitory computer readable storage medium having stored thereon processor-executable software instructions configured to cause a processor of a server computing device to perform operations including generating granular resource units that each identify an amount of a telecommunication resource that is offered for allocation and use by other networks with respect to an area or volume, and offering the resource units for purchase, lease, or trade on a commodities exchange. In an embodiment, the stored processor-executable instructions may be configured to cause a processor to perform operations such that generating the granular resource units includes generating resource units that use a universal standard to identify, quantify, measure, and represent the telecommunication resource. In a further embodiment, the stored processor-executable instructions may be configured to cause a processor to perform operations such that generating the granular resource units includes generating resource units that identify the telecommunication resource in a standardized format and structure.

In a further embodiment, the stored processor-executable instructions may be configured to cause a processor to perform operations such that generating the granular resource units includes generating resource units that include a common reference point that is suitable for use in comparing the granular resource units against other resource units. In a further embodiment, the stored processor-executable instructions may be configured to cause a processor to perform operations further including comparing two or more resource units that represent different resource offerings from different networks to determine the relative economic value of the offered amounts of telecommunication resource. In a further embodiment, the stored processor-executable instructions may be configured to cause a processor to perform operations such that generating the granular resource units includes generating resource units that define an amount of bandwidth in relation to a geographic area encompassing one cubic meter.

In a further embodiment, the stored processor-executable instructions may be configured to cause a processor to perform operations such that generating the granular resource units includes generating resource units that may be combined to cover a well-defined area. In a further embodiment, the stored processor-executable instructions may be configured to cause a processor to perform operations further including combining the resource units to cover an area that encompasses one of a highway portion, a bridge, a navigation path, a waterway portion, and air traffic corridor. In a further embodiment, the stored processor-executable instructions may be configured to cause a processor to perform operations such that the resource units are resource cubes that include an altitude dimension, the method further including combining the resource units to cover one or more floors of an office building. In a further embodiment, the stored processor-executable instructions may be configured to cause a processor to perform operations such that offering the resource units for purchase, lease, or trade on a commodities exchange includes grouping the resource units to form a polygon, and offering the group of resource units for purchase, lease, or trade on the commodities exchange.

### BRIEF DESCRIPTION OF THE DRAWINGS

The accompanying drawings, which are incorporated herein and constitute part of this specification, illustrate exemplary embodiments of the invention, and, together with the general description given above and the detailed description given below, serve to explain features of the invention.

FIGS. 1A through 1E are system block diagrams illustrating various logical and functions components and communication links in communication systems that may be used to implement the various embodiments.

FIG. 2 is a process flow diagram illustrating a dynamic spectrum arbitrage (DSA) method of allocating the rights for the access and use of a telecommunication resource that is associated with a resource unit or group of resource units in accordance with an embodiment.

FIG. 3A is a block diagram illustrating a resource unit that defines an amount of bandwidth in relation to a three dimensional area in accordance with the various embodiments.

FIG. 3B is a table diagram illustrating example data fields that may be stored in association with a resource unit to identify the characteristics and/or properties of the underlying telecommunication resources in accordance with some embodiments.

FIG. 4 is a block diagram illustrating geographical boundaries that may be represented by a resource unit in various embodiments.

FIGS. 5A and 5B are block diagrams illustrating that resource units may be combined to define polygons that cover different geographical areas.

FIG. 5C is a block diagram illustrating that resource units may combined or arranged to cover a geographical area that forms an irregular shape.

FIGS. 6A and 6B are block diagrams illustrating that resource cubes may be combined or grouped to define polygons that cover different geographical areas.

FIG. 6C is a table diagram illustrating example data fields that may be stored in association with a resource cube or resource cube grouping to identify the characteristics and/or properties of the underlying telecommunication resources in accordance with some embodiments.

FIGS. 7A and 7B are block diagrams illustrating embodiment resource unit groupings that share common geodetic reference points.

FIG. 7C is a block diagram illustrating that resource unit groupings that are aggregated to increase the availability of the telecommunication resource in accordance with an embodiment.

FIGS. 8A through 8C are block diagrams illustrating resource unit groupings that may be generated and used by the various embodiments.

FIGS. 9A through 9C are illustrations of additional resource unit groupings that may be generated and used by the various embodiments.

FIG. 10 is a block diagram illustrating resource cubes grouped to cover floors of a building or structure in accordance with an embodiment.

FIG. 11 is a block diagram illustrating resource cubes grouped to cover an area that encompassed a corridor in accordance with another embodiment.

FIG. 12 is a block diagram illustrating resource cubes grouped to cover a long and narrow area in accordance with another embodiment.

FIGS. 13 through 16 are process flow diagrams illustrating DSA methods of generating and using resource units in accordance with various embodiments.

FIG. 17 is a component block diagram of an example wireless device suitable for use with the various embodiments.

FIG. 18 is a component block diagram of a server suitable for use with an embodiment.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

In overview, the various embodiments include methods, and systems and components (e.g., server computing devices, etc.) configured to implement the methods, for dynamically managing the availability, allocation, access, and use of telecommunication resources between participating networks. As part of these operations, the systems/components may be configured to generate granular resource units that each identify an amount of a telecommunication resource that is offered for allocation and use by other networks with respect to an area or volume, and offer the resource units for purchase, lease, or trade on a commodities exchange. These operations may be performed in conjunction with other DSA operations, such as determining an amount of radio frequency (RF) spectrum resources available for allocation within a first communication network, dynamically allocating a portion of available RF spectrum resources of the first communication network for access and use by a second communication network, informing the second communication network that use of allocated RF spectrum resources may begin, recording a transaction in a transaction database identifying an amount of RF spectrum resources allocated for use by the second communication network, determining whether at least some of the allocated RF spectrum resources are required by the first communication network, informing the second communication network that use of allocated RF spectrum resources should be terminated in response to determining that at least some of the allocated RF spectrum resources are required by the devices in the first communication network, and updating the transaction database to include information identifying a time when use of the allocated RF spectrum resources was terminated by the second communication network.

Other example DSA operations include establishing a communication link between a communications server and a plurality of communication networks, determining in the communications server whether a telecommunication resource of a first communication network of the plurality of communication networks is available for allocation based on information received via the communication link, broadcasting a communication signal that includes information suitable for informing the plurality of communication networks that the telecommunication resource is available for allocation via an auction and including an auction start time for the auction, receiving credential information from the plurality of communication networks (e.g., credential information identifying a type of geographic area, a wireless access technology, a frequency of operation, an amount of bandwidth, a duration for use of the telecommunication resource, a start time, an end time, etc.), using the received credential information to determine that one or more networks in the plurality of communication networks is eligible to participate in the auction (e.g., a second communication network), receiving bids from the plurality of communication networks for the telecommunication resource determined to be available for allocation in response to broadcasting the communication message and after the auction start time included in the broadcast communication signal, accepting only the bids received from the plurality of communication networks determined to be eligible to participate in the auction, allocating the telecommunication resource of the first communication network for access and use by the second communication network in the plurality of communication networks based on accepted bids, sending a communication message to the second communication network (e.g., a message that includes information suitable for informing the second communication network that use of allocated telecommunication resource may begin), and recording a transaction in a transaction database identifying the telecommunication resource as being allocated for use by the second communication network.

As used herein, the terms “wireless device,” “mobile device” and “user equipment (UE)” may be used interchangeably and refer to any one of various cellular telephones, personal data assistants (PDA's), palm-top computers, laptop computers with wireless modems, wireless electronic mail receivers (e.g., the Blackberry® and Treo® devices), multimedia Internet enabled cellular telephones (e.g., the iPhone®), and similar personal electronic devices. A wireless device may include a programmable processor and memory. In a preferred embodiment, the wireless device is a cellular handheld device (e.g., a wireless device), which can communicate via a cellular telephone communications network.

As used in this application, the terms “component,” “module,” and the like are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, a computer, a server, network hardware, etc. By way of illustration, both an application running on a computing device and the computing device may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon.

A number of different cellular and mobile communication services and standards are available or contemplated in the future, all of which may implement and benefit from the various embodiments. Such services and standards include, e.g., third generation partnership project (3GPP), long term evolution (LTE) systems, third generation wireless mobile communication technology (3G), fourth generation wireless mobile communication technology (4G), global system for mobile communications (GSM), universal mobile telecommunications system (UMTS), 3GSM, general packet radio service (GPRS), code division multiple access (CDMA) systems (e.g., cdmaOne, CDMA2000TM), enhanced data rates for GSM evolution (EDGE), advanced mobile phone system (AMPS), digital AMPS (IS-136/TDMA), evolution-data optimized (EV-DO), digital enhanced cordless telecommunications (DECT), Worldwide Interoperability for Microwave Access (WiMAX), wireless local area network (WLAN), public switched telephone network (PSTN), Wi-Fi Protected Access I & II (WPA, WPA2), Bluetooth®, integrated digital enhanced network (iden), land mobile radio (LMR), and evolved universal terrestrial radio access network (E-UTRAN). Each of these technologies involves, for example, the transmission and reception of voice, data, signaling and/or content messages. It should be understood that any references to terminology and/or technical details related to an individual telecommunication standard or technology are for illustrative purposes only, and are not intended to limit the scope of the claims to a particular communication system or technology unless specifically recited in the claim language.

The various embodiments include a dynamic spectrum arbitrage (DSA) system configured to dynamically manage the availability, allocation, access, and use of telecommunication resources, such as radio frequency (RF) spectrum resources, between participating networks. In overview, the DSA system allows two or more networks (e.g., lessor and lessee networks) to collaborate and make better use their resources by leasing resources during times of high congestion and leasing out resources when they are not in use. For example, the DSA system may include components configured to determine resources are available (e.g., not in use) in a first telecommunication network, conduct an auction for the available resources among participating networks, select a second telecommunication network to which the available resources are to be allocated, and allocate the available resources of the first telecommunication network for access and use by wireless devices associated with the second telecommunication network. A detailed description of an example DSA system is provided in U.S. Pat. No. 8,711,721 dated Apr. 29, 2014, the entire contents of which are hereby incorporated by reference in their entirety and for all purposes.

The DSA system may include or communicate with a telecommunications commodity exchange (TCE) component that is configured to utilize the features provided by the DSA system to conduct or manage the auction for the available resources. The TCE component may be configured to allow participating networks, investors, speculators, and new entrants (collectively “participants”) to buy, sell, exchange, and invest in telecommunication resources. For example, in an embodiment, the TCE component may be configured to pool resources made available by multiple networks and conduct a resource auction for all or portions of the resources in the resource pool. As part of these operations, the TCE component may receive resource bids from multiple participants, identify the participant that submitted highest bid as the winner of the resource auction, and allocate the auctioned resources to the winning participant.

Thus, the TCE component allows participating networks to make more efficient use of their excess resources (i.e., resources that would otherwise go unused for significant periods of time) by allowing them to sell or lease these resources to the highest bidder. The TCE component also allows participating networks to lease resources from other networks at competitive market rates that more accurately reflect the economic principles of supply and demand.

In addition, the TCE may allow participants to invest in future allocations of the telecommunication resources. For example, the TCE component may be configured to allow a participant to buy or sell futures contracts in RF spectrum. Such futures contracts may provide an assurance that a lessor network will allocate a specified quantity of RF spectrum to a lessee network at a future date for a presently agreed upon price. This, in turn, allows the lessee network to better manage or hedge against future costs, or to speculate regarding future increases or decreases in the costs or demand for RF spectrum resources.

To accomplish the above-mentioned functions, the TCE component (or another component in the DSA system) may be required to measure, pool, divide, offer for sale/lease, and distribute telecommunication resources. A telecommunication resource may be (or may include) any signal, element, component, and/or system that is used by participating networks to communicate information wirelessly or over the air. For example, a telecommunication resource may including all or portions of the electromagnetic spectrum (e.g., radio frequency spectrum, microwave spectrum, etc.), a frequency or frequency range, a frequency band, a channel, bandwidth, a stream, a transmission path, a communication link, carriers, sub-carriers, frames, superframes, samples, cells, etc. A telecommunication resource may also include all or portions of the functions, operations, or services provided by radio towers, cell sites, base stations, eNodeBs, and other well-known network components.

Due to the variance, variety, and complexity of the telecommunication resources, it is often challenging to represent, express, or offer telecommunication resources in uniform quantities or units that investors and other participants can readily understand. It is also challenging to properly quantify, assess, or compare the relative economic values of the telecommunication resources.

For example, telecommunication resources are typically associated with a physical or semi-physical resource boundary, such as a cell site, coverage area, a license area, subset of a license area, etc. Such resource boundaries may vary based on the resource, the network, or the allocation scheme used for allocating the resource. As such, existing solutions require that a DSA system use polygons to define the geographic areas in which the wireless devices of the lessee network are authorized to use an allocated resource. Yet, the polygons that are generated using existing solutions are not well suited for use in representing telecommunication resources in a commodities exchange system. This is because, while such polygons may reduce the variability of the geographic boundaries, the shape and size of the polygons may still differ based on the resource, the network, the allocation scheme used to allocate the resource, etc. These differences (e.g., in the shape and size of the polygons) typically increase the computational complexity associated with appraising or comparing different resource offerings from different networks, and make it more challenging to determine the relative economic value of a telecommunication resource that is offered for sale or lease. These and other challenges may discourage or detract investors from investing in or trading telecommunication resources alongside more traditional commodities, such as gold, oil, or natural gas. These challenges may also limit the DSA system's ability to efficiently offer telecommunication resources for purchase, lease, or trade as a commodity.

To better support the trade of telecommunication resources as a commodity, the various embodiments include components configured to identify, define, quantify, pool, partition, organize, and/or package telecommunication resources into well-defined, granular, discrete, standardized, and fungible resource units that are well suited for comparison and/or mutual substitution. These resource units may allow the DSA system to offer the telecommunication resources for purchase, lease, or trade on a commodities exchange alongside more traditional commodities, such as gold, oil, and natural gas. The resource units also may allow the DSA system to present telecommunication resources to investors in a format, structure, or in units that are more readily understood by the trading community. As such, the various embodiments allow the DSA system to efficiently offer and trade telecommunication resources in a commodity exchange system, thereby improving the efficiency, performance, usability, and functionality of the DSA system and its constituent components (e.g., TCE component, etc.).

The various embodiments may include components configured to generate resource units that use a universal standard to identify, quantify, measure, and/or represent the telecommunication resources. Such resource units may include or provide a common reference point against which other resource units and telecommunication resources may be compared. By generating and using such resource units, the various embodiments may reduce the computational complexity associated with comparing different resource offerings from different networks, and/or may allow commodity traders to more readily compare and valuate different telecommunication resource offerings from different networks.

Some embodiments may include components configured to generate the resource units so that they define each telecommunication resource granularly, in relation to an area or resource boundary, and/or so that the resulting resource units may be combined. For example, the components may generate the resource units so that they define an amount of bandwidth or capacity (e.g., 100 megabits/second) in relation to a well-defined resource boundary (e.g., a geographic area encompassing one cubic meter, one square kilometer, etc.). Such resource units may be combined to create a resource boundary that covers a precise location or area, such as an area that encompasses a highway but excludes its surrounding office buildings. This provides the participants with fine grain controls over the resources they offer, lease or purchase. Further, by generating granular and combinable resource units that each define a specific resource with respect to a relatively small and well-defined area (e.g., bandwidth at 10 megabits per second for an area encompassing one cubic meter), the various embodiments allow lessee networks to purchase/lease only the resources they require (e.g., over the highway) and/or for lessor networks to more narrowly slice their available resources so that they may be priced more competitively and/or leased to more consumers. For these and other reasons, the generation and use of granular/combinable resource units (e.g., by the DSA components, etc.) may improve the efficiency, performance, usability, and functionality of the DSA system and its constituent components (e.g., TCE component, etc.)

Some embodiments may include components configured to generate the resource units so that they include information identifying various characteristics and/or properties of the telecommunications resource or offering, such as the radio access network technologies that are supported or compatible with the offered resource or network, the geographic area(s) in which the resource is offered for use, a resource availability time or date, a resource expiration time, a lease duration, lease start and stop times or dates, a pairing status, frequency units (FUs), an uplink/downlink symmetry value or ratio, transmit/receive frequency unit start and stop values, the service class of the resource or offering, the public land mobile network (PLMN) identifier of the lessor network offering the resource, the name of the lessor network, an absolute radio-frequency channel number (ARFCN), a channel bandwidth, a total available bandwidth, peak data rate, and other similar information.

Some embodiments may include components configured to generate the resource units so that they use universal standards or units to identify or describe the characteristics/properties of the telecommunication resource or offering. This allows the DSA system, participants, and analysts to more readily and directly compare resource units that represent different resources. This, in turn, reduces the computational complexity associated with determining the relative economic value of a telecommunication resource that is offered for sale or lease, and improves the efficiency, performance, usability, and functionality of the DSA system and its constituent components (e.g., TCE component, etc.).

Some embodiments may include components configured to classify or grade the telecommunication resources or resource units. The components may classify/grade a resource unit based on the properties or characteristics of its underlying resource. For example, similar to how oil is graded as “sweet” or “sour” based on its sulfur content and “light” or “heavy” based on its relative density, the components may be configured generate, classify, categorize, package, group, label, and/or offer telecommunications resources and/or resource units graded (e.g., as wide, narrow, sweet, sour, light, heavy, durable, non-durable, hard, soft, etc.) based on the radio access network technologies supported, the geographic areas in which the resource is offered for use, wavelength, resource expiration time, lease duration, or any property or characteristic (or combinations thereof) of the underlying resource(s).

In some embodiments, the DSA system may include components configured to offer resource units for purchase or lease on the commodity exchange based on their grade(s) or classification(s) (e.g., wide, heavy, soft, etc.). This allows the commodity traders (and other participants) to better understand the properties and characteristics of the resources offered by a resource unit, which in turn allows them to more accurately determine the relative economic values of that resource unit. In some embodiments, the grades and/or classifications that are associated with the telecommunication resources or resource units may be stored in a database (accessible to the DSA components) in conjunction with the defining properties or characteristics used to classify or grade them resources/units.

Various embodiments may include components configured to generate the resource units so that they represent a telecommunication resource (e.g., bandwidth, radio frequency spectrum, etc.) with respect to a geographic location, area, time, volume, density, temperature, wavelength, or any other measurable characteristic of the telecommunications resource or its offering. For example, a component may be configured to generate a resource unit so that it identifies a quantity or amount of an offered resource (e.g., 100 megabits/second of bandwidth) with respect a two or three dimensional area (e.g., a one square meter, a cubic meter, etc.). The two or three dimensional area may be defined via of a variety of grid, location, and geographic coordinate systems that are known in the art, such as the Cartesian coordinate system, a polar coordinate system, a cylindrical or spherical coordinate system, an Euclidean system, the Universal Transverse Mercator System (UTM), the Spatial Reference System (SRS), the Coordinate Reference System (CRS), etc. Select systems and methods for representing the telecommunication resource with respect to two and three dimensional areas are discussed in detail further below.

In an embodiment, a component may be configured to generate a resource unit that identifies a quantity or amount of an offered resource (e.g., 100 megabits/second of bandwidth) with respect to a three dimensional area. This resource unit may identify a geographic location (or point of origin) and coordinate values (e.g., X, Y, and Z) that represent the length, width, and height of an area in which the resource may be used by a lessee network (i.e., the network that purchases the resource unit or wins the resource auction). The resource unit may define the height of the three dimensional area based on altitude, such as relative to the mean sea level (MSL), the above ground level (AGL), or relative to a reference point that is above MSL or AGL (e.g., 100 meters above AGL).

Resource units that define a resource with respect to a three dimensional area may referred to herein as “resource cubes,” “resource unit cubes.” A resource unit that identifies an amount of bandwidth with respect to a three dimensional area may be referred to as a “bandwidth unit cube” or “BU cube.”

Some embodiments may include components configured to group or combine resource units to generate polygons or other geodetic groupings. The components may also submit these groupings for trade on the commodities exchange as a single unit. Resource cubes that are grouped into a polygon may be submitted to the commodities exchange system as an “orthogonal resource grouping.” BU cubes that are grouped into a polygon may be submitted to the commodities exchange system as a “broadband orthogonal resource grouping.”

To focus the discussion on the relevant features, some of the embodiments are described using radio frequency (RF) spectrum and bandwidth as exemplary telecommunication resources. However, it should be understood that a resource unit may identify, define, quantify, pool, partition, organize, and/or package any telecommunication resource, and thus nothing in this application should be used to limit the scope of the claims to any individual telecommunication resource unless expressly recited as such in the claim language.

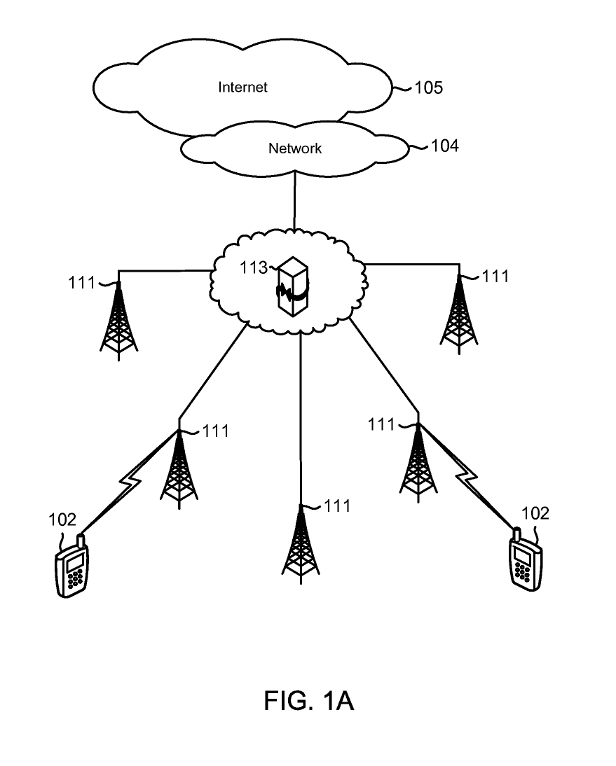

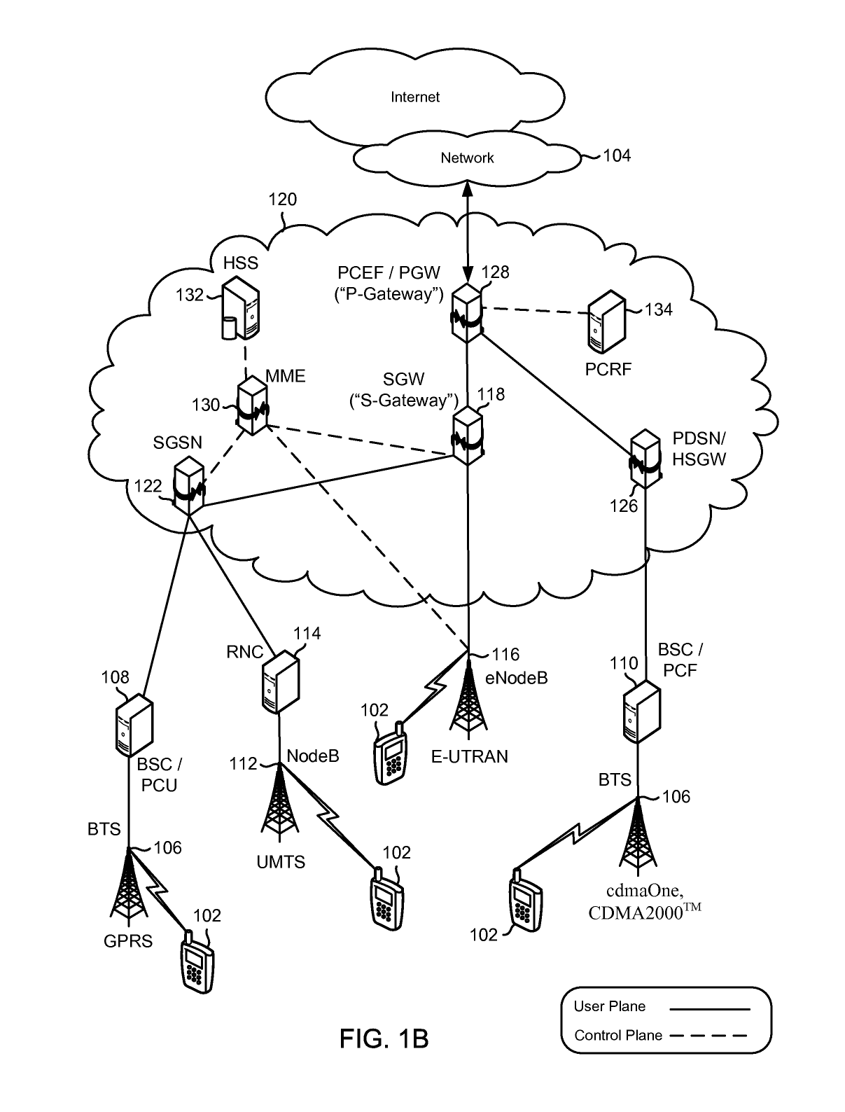

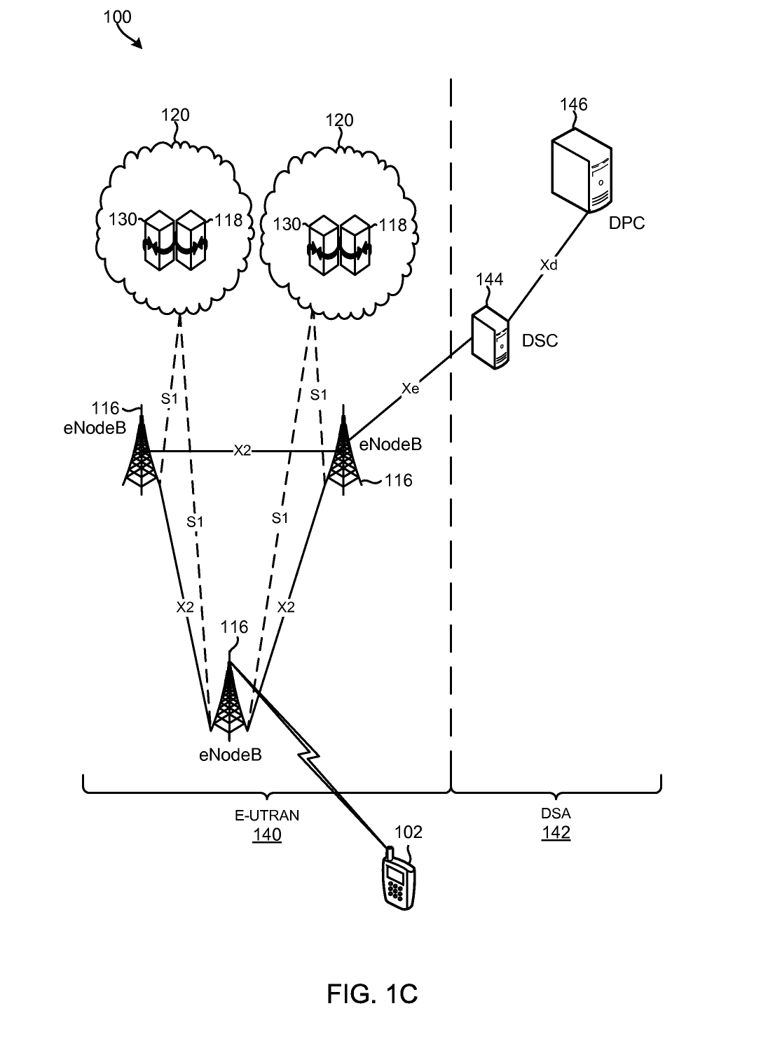

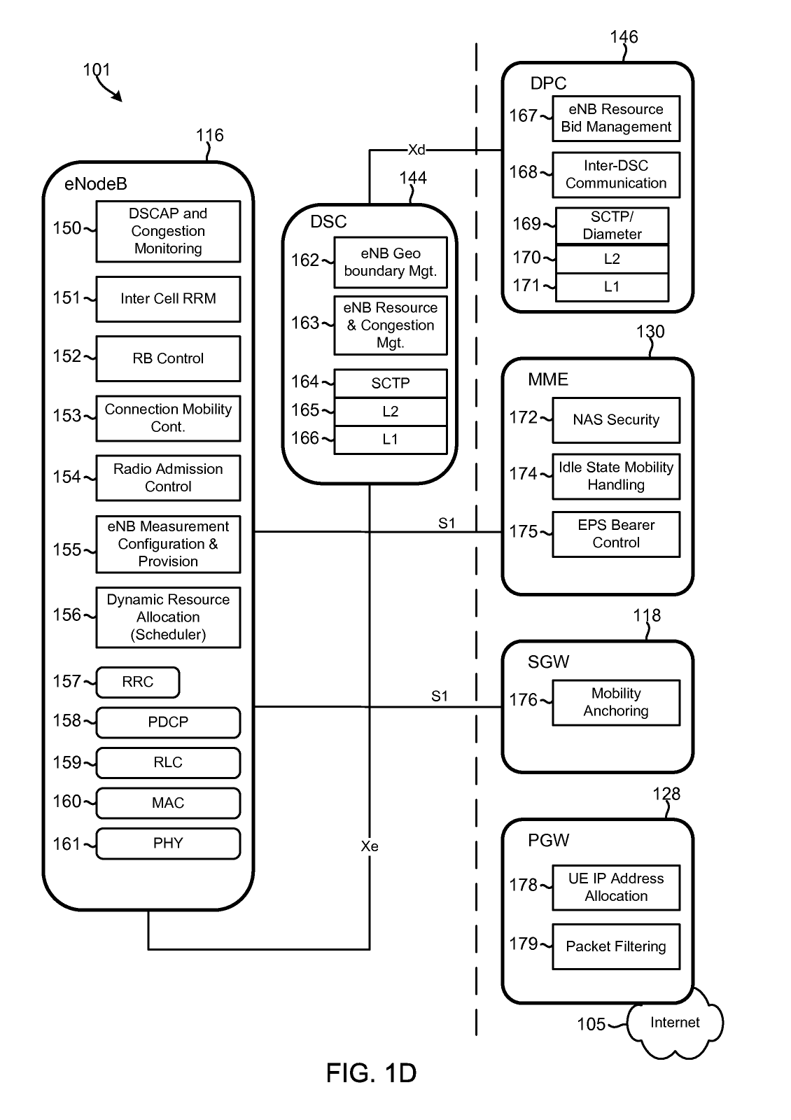

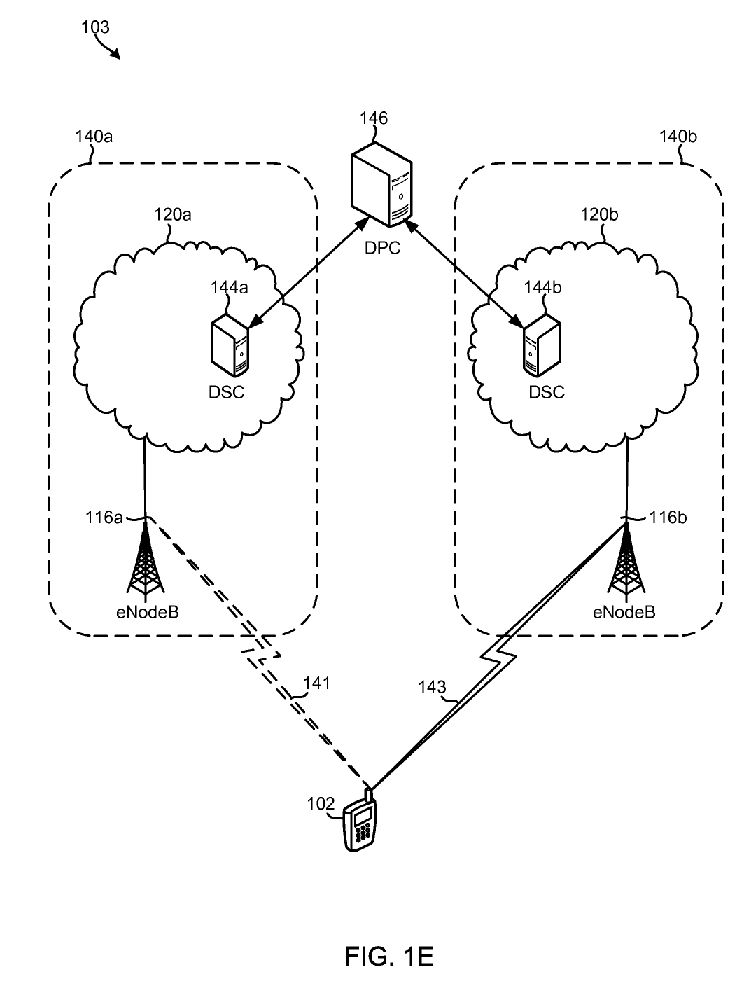

The various embodiments may be implemented within a variety of communication systems, examples of which are illustrated in FIGS. 1A-1E. With reference to FIG. 1A, wireless devices 102 may be configured to transmit and receive voice, data, and control signals to and from a base station 111, which may be a base transceiver station (BTS), NodeB, eNodeB, etc. The base station 111 may communicate with an access gateway 113, which may include one or more of a controller, a gateway, a serving gateway (SGW), a packet data network gateway (PGW), an evolved packet data gateway (ePDG), a packet data serving node (PDSN), a serving GPRS support node (SGSN), or any similar component or combinations of the features/functions provided thereof. Since these structures are well known and/or discussed in detail further below, certain details have been omitted from FIG. 1A in order to focus the descriptions on the most relevant features.

The access gateway 113 may be any logical and/or functional component that serves as the primary point of entry and exit of wireless device traffic and/or connects the wireless devices 102 to their immediate service provider and/or packet data networks (PDNs). The access gateway 113 may forward the voice, data, and control signals to other network components as user data packets, provide connectivity to external packet data networks, manage and store contexts (e.g. network internal routing information, etc.), and act as an anchor between different technologies (e.g., 3GPP and non-3GPP systems). The access gateway 113 may coordinate the transmission and reception of data to and from the Internet 105, as well as the transmission and reception of voice, data and control information to and from an external service network 104, the Internet 105, other base stations 111, and to wireless devices 102.

In various embodiments, the base stations 111 and/or access gateway 113 may be coupled (e.g., via wired or wireless communication links) to a dynamic spectrum arbitrage (DSA) system configured to dynamically manage the availability, allocation, access, and use of various network resources (e.g., RF spectrum, RF spectrum resources, etc.). The DSA system is discussed in detail further below.

FIG. 1B illustrates that wireless devices 102 may be configured to send and receive voice, data and control signals to and from the service network 104 (and ultimately the Internet 105) using a variety of communication systems/technologies (e.g., GPRS, UMTS, LTE, cdmaOne, CDMA2000TM), any or all of which may be supported by, or used to implement, the various embodiments.

In the example illustrated in FIG. 1B, long term evolution (LTE) and/or evolved universal terrestrial radio access network (E-UTRAN) data transmitted from a wireless device 102 is received by an eNodeB 116, and sent to a serving gateway (SGW) 118 located within the core network 120. The eNodeB 116 may send signaling/control information (e.g., information pertaining to call setup, security, authentication, etc.) to a mobility management entity (MME) 130. The MME 130 may request user/subscription information from a home subscriber server (HSS) 132, communicate with other MME components, perform various administrative tasks (e.g., user authentication, enforcement of roaming restrictions, etc.), select a SGW 118, and send authorization and administrative information to the eNodeB 116 and/or SGW 118. Upon receiving the authorization information from the MME 130 (e.g., an authentication complete indication, an identifier of a selected SGW, etc.), the eNodeB 116 may send data received from the wireless device 102 to a selected SGW 118. The SGW 118 may store information about the received data (e.g., parameters of the IP bearer service, network internal routing information, etc.) and forward user data packets to a policy control enforcement function (PCEF) and/or packet data network gateway (PGW) 128.

FIG. 1B further illustrates that general packet radio service (GPRS) data transmitted from the wireless devices 102 may be received by a base transceiver station (BTS) 106 and sent to a base station controller (BSC) and/or packet control unit (PCU) component (BSC/PCU) 108. Code division multiple access (CDMA) data transmitted from a wireless device 102 may be received by a base transceiver station 106 and sent to a base station controller (BSC) and/or packet control function (PCF) component (BSC/PCF) 110. Universal mobile telecommunications system (UMTS) data transmitted from a wireless device 102 may be received by a NodeB 112 and sent to a radio network controller (RNC) 114.

The BSC/PCU 108, BSC/PCF 110, and RNC 114 components may process the GPRS, CDMA, and UMTS data, respectively, and send the processed data to a component within the core network 120. More specifically, the BSC/PCU 108 and RNC 114 units may send the processed data to a serving GPRS support node (SGSN) 122, and the BSC/PCF 110 may send the processed data to a packet data serving node (PDSN) and/or high rate packet data serving gateway (HSGW) component (PDSN/HSGW) 126. The PDSN/HSGW 126 may act as a connection point between the radio access network and the IP based PCEF/PGW 128. The SGSN 122 may be responsible for routing the data within a particular geographical service area, and send signaling (control plane) information (e.g., information pertaining to call setup, security, authentication, etc.) to an MME 130. The MME 130 may request user and subscription information from a home subscriber server (HSS) 132, perform various administrative tasks (e.g., user authentication, enforcement of roaming restrictions, etc.), select a SGW 118, and send administrative and/or authorization information to the SGSN 122.

The SGSN 122 may send the GPRS/UMTS data to a selected SGW 118 in response to receiving authorization information from the MME 130. The SGW 118 may store information about the data (e.g., parameters of the IP bearer service, network internal routing information, etc.) and forward user data packets to the PCEF/PGW 128. The PCEF/PGW 128 may send signaling information (control plane) to a policy control rules function (PCRF) 134. The PCRF 134 may access subscriber databases, create a set of policy rules and performs other specialized functions (e.g., interacts with online/offline charging systems, application functions, etc.). The PCRF 134 may then send the policy rules to the PCEF/PGW 128 for enforcement. The PCEF/PGW 128 may implement the policy rules to control the bandwidth, the quality of service (QoS), the characteristics of the data, and the services being communicated between the service network 104 and the end users.

In the various embodiments, any or all of the components discussed above (e.g., components 102-134) may be coupled to, or included in, a DSA system configured to dynamically manage the availability, allocation, access, and use of telecommunication resources.

FIG. 1C illustrates various logical components and communication links in an embodiment system 100 that includes an DSA system 142 and a evolved universal terrestrial radio access network (E-UTRAN) 140. In the example illustrated in FIG. 1C, the DSA system 142 includes a dynamic spectrum controller (DSC) 144 component and a dynamic spectrum policy controller (DPC) 146 component. The E-UTRAN 140 includes a plurality of interconnected eNodeBs 116 coupled to the core network 120 (e.g., via a connection to an MME, SGW, etc.).

In various embodiments, the DSC 144 may be included in or coupled to the E-UTRAN 140, either as part of its core network 120 or outside of the core network 120. In an embodiment, the DSC 144 may be coupled directly (e.g., via wired or wireless communication links) to one or more eNodeBs 116. In an embodiment, the DPC 146 may include communication links to a telecommunications commodity exchange (TCE) component (not illustrated in FIG. 1C). In an embodiment, the DPC 146 may include a TCE component.

The eNodeBs 116 may be configured to communicate with the DSC 144 via the Xe interface/reference point. The DSC 144 may be configured to communicate with the DPC 146 via the Xd interface/reference point. The eNodeBs 116 may be interconnected, and configured to communicate via an X2 interface/reference point. The eNodeBs 116 may be configured to communicate with components in the core network 120 via the S1 interface. For example, the eNodeBs 116 may be connected to an MME 130 via the S1-MME interface and to a SGW 118 via the S1-U interface. The S1 interface may support a many-to-many relation between the MMEs 130, SGWs 118, and eNodeBs 116. In embodiment, the DPC and/or DSC component may also be configured to communicate with a HSS 132 component.

The eNodeBs 116 may be configured to provide user plane (e.g., PDCP, RLC, MAC, PHY) and control plane (RRC) protocol terminations towards the wireless device 102. That is, the eNodeBs 116 may act as a bridge (e.g., layer 2 bridge) between the wireless devices 102 and the core network 120 by serving as the termination point of all radio protocols towards the wireless devices 102, and relaying voice (e.g., VoIP, etc.), data, and control signals to network components in the core network 120. The eNodeBs 116 may also be configured to perform various radio resource management operations, such as controlling the usage of radio interfaces, allocating resources based on requests, prioritizing and scheduling traffic according to various quality of service (QoS) requirements, monitoring the usage of network resources, etc. In addition, the eNodeBs 116 may be configured to collect radio signal level measurements, analyze the collected radio signal level measurements, and handover wireless devices 102 (or connections to the mobile devices) to another base station (e.g., a second eNodeB) based on the results of the analysis.

The DSC 144 and DPC 146 may be functional components configured to manage the dynamic spectrum arbitrage process for sharing radio frequency and other network resources between different E-UTRANs 140. For example, the DPC 146 component may be configured to manage the DSA operations and interactions between multiple E-UTRAN networks by communicating with DSCs 144 in the E-UTRAN network.

FIG. 1D illustrates various logical and functional components that may be included in a communication system 101 that suitable for use in performing DSA operations in accordance with various embodiments. In the example illustrated in FIG. 1D, the communication system 101 includes an eNodeB 116, a DSC 144, a DPC 146, an MME 130, a SGW 118, and a PGW 128.

The eNodeB 116 may include a DSC application protocol and congestion monitoring module 150, an inter-cell radio resource management (RRM) module 151, a radio bearer (RB) control module 152, a connection mobility control module 153, a radio admission control module 154, an eNodeB measurement configuration and provision module 155, and a dynamic resource allocation module 156. Each of these modules 150-156 may be implemented in hardware, in software, or in a combination of hardware and software.

In addition, the eNodeB 116 may include various protocol layers, including a radio resource control (RRC) layer 157, a packet data convergence protocol (PDCP) layer 158, a radio link control (RLC) layer 159, a medium access control (MAC) layer 160, and a physical (PHY) layer 161. In each of these protocol layers, various hardware and/or software components may implement functionality that is commensurate with responsibilities assigned to that layer. For example, data streams may be received in the physical layer 161, which may include a radio receiver, buffers, and processing components that perform the operations of demodulating, recognizing symbols within the radio frequency (RF) signal, and performing other operations for extracting raw data from the received RF signal.

The DSC 144 may include an eNodeB geographic boundary management module 162, an eNodeB resource and congestion management module 163, a stream control transmission protocol (SCTP) module 164, a Layer-2 (L2) buffer module 165, and a Layer-1 (L1) buffer module 166. The DPC 146 may include an eNodeB resource bid management module 167, an inter-DSC communication module 168, SCTP/DIAMETER module 169, an L2 buffer module 170, and a L1 buffer module 171. The MME 130 may include a non-access stratum (NAS) security module 172, and idle state mobility handling module 173, and an evolved packet system (EPS) bearer control module 174. The SGW 118 may include a mobility anchoring module 176. The PGW 128 may include a UE IP address allocation module 178 and a packet filtering module 179. Each of these modules 162-179 may be implemented in hardware, in software, or in a combination of hardware and software.

The eNodeB 116 may be configured to communicate with the SGW 118 and/or MME 130 via the S1 interface/protocol. The eNodeB 116 may also be configured to communicate with the DSC 144 via the Xe interface/protocol. The DSC 144 may be configured to communicate with the DPC 146 via the Xd interface/protocol.

The eNodeB 116 may be configured to perform various operations (e.g., via modules/layers 150-161) to provide various functions, including functions for radio resource management, such as radio bearer control, radio admission control, connection mobility control, dynamic allocation of resources to wireless devices 102 in both uplink and downlink (scheduling), etc. These functions may also include IP header compression and encryption of user data stream, selection of an MME at UE attachment when no routing to an MME 130 can be determined from the information provided by the UE, routing of user plane data towards SGW 118, scheduling and transmission of paging messages (originated from the MME), scheduling and transmission of broadcast information (originated from the MME), measurement and measurement reporting configuration for mobility and scheduling, scheduling and transmission of public warning system (e.g., earthquake and tsunami warning system, commercial mobile alert service, etc.) messages (originated from the MME), closed subscriber group (CSG) handling, and transport level packet marking in the uplink. In an embodiment, the eNodeB 116 may be a donor eNodeB (DeNB) that is configured to perform various operations to provide additional functions, such as an S1/X2 proxy functionality, S11 termination, and/or SGW/PGW functionality for supporting relay nodes (RNs).

The MME 130 may be configured to perform various operations (e.g., via modules 172-175) to provide various functions, including non-access stratum (NAS) signaling, NAS signaling security, access stratum (AS) security control, inter-CN node signaling for mobility between 3GPP access networks, idle mode UE reach-ability (including control and execution of paging retransmission), tracking area list management (e.g., for a wireless device in idle and active mode), PGW and SGW selection, MME selection for handovers with MME change, SGSN selection for handovers to 2G or 3G 3GPP access networks, roaming, authentication, bearer management functions including dedicated bearer establishment, support for public warning system (e.g., earthquake and tsunami warning system, commercial mobile alert service, etc.) message transmission, and performing paging optimization. The MME module may also communicate various device state and attach/detach status information to the DSC. In an embodiment, the MME 130 may be configured to not filter paging massages based on the CSG IDs towards macro eNodeBs.

The SGW 118 may be configured to perform various operations (e.g., via module 176) to provide various functions, including mobility anchoring (e.g., for inter-3GPP mobility), serving as a local mobility anchor point for inter-eNodeB handovers, E-UTRAN idle mode downlink packet buffering, initiation of network triggered service request procedures, lawful interception, packet routing and forwarding, transport level packet marking in the uplink (UL) and the downlink (DL), accounting on user and QoS class identifier (QCI) granularity for inter-operator charging, uplink (UL) and the downlink (DL) charging (e.g., per device, PDN, and/or QCI), etc.

The PGW 128 may be configured to perform various operations (e.g., via modules 178-179) to provide various functions, including per-user based packet filtering (by e.g. deep packet inspection), lawful interception, UE IP address allocation, transport level packet marking in the uplink and the downlink, UL and DL service level charging, gating and rate enforcement, DL rate enforcement based on APN-aggregate maximum bit rate (AMBR), etc.

The DSC 144 may be configured to perform various operations (e.g., via modules 162-166) to provide various functions, including managing resource arbitration operations within a network (e.g., PLMN), tracking network resource listings, tracking current bids in progress, tracking executed bids, and tracking bid specific closed subscriber group (CSG) identifiers (CSG-IDs) for mobility management of lessee wireless devices 102 in lessor networks. The DSC 144 may be configured to handover wireless devices 102 from lessee network to lessor network (i.e., perform handins), and handover wireless devices 102 from lessor network back to lessee network (i.e., perform backoff).

The DSC 144 may also be configured to track congestion states of eNodeBs, select target eNodeBs for handovers, and manage traffic on lessor eNodeBs. The DSC 144 may be configured to offload users based on configured policies (e.g. offload lower priority users, offload higher priority users, offload users with specific QoS, etc.) from lessee networks to other less loaded eNodeBs 116 within a lessor network. The DSC 144 may also perform backoff operations to handover a wireless device 102 from lessor network back to the lessee network. The DSC 144 may also be configured to monitor, manage, and/or maintain historic congestion information that is collected or received from one or more eNodeBs in the system.

The DPC 146 may be configured to perform various operations (e.g., via modules 167-171) to provide various functions, including functioning as a resource arbitrage broker between the DSCs 144 of lessor and lessee networks (e.g., PLMNs), listing resources from various lessor networks for auction, and managing the auction process. The DPC 146 may be configured to send notifications of outbid, bid win, bid cancel and bid withdrawal and bid expiry to DSCs 144, install bid specific charging rules in the online and/or offline charging systems of lessee and lessor networks, and coordinate resource usage between DSCs 144 by acting as gateway between lessee and lessor DSCs 144.

FIG. 1E illustrates network components and information flows in an example communication system 103 that includes two E-UTRANs 140a, 140b interconnected by a DPC 146 configured to manage DSA operations and interactions. In the example illustrated in FIG. 1E, each E-UTRAN 140a, 140b includes an eNodeB 116a, 116b that is outside of its core network 120a, 120b, and a DSC 144a, 144b that is inside of the core network 120a, 120b.

The DSCs 144a, 144b may be configured to communicate with the DPC 146 via Xd interface. The DSCs 144a, 144b may also be connected, directly or indirectly, to various network components in their respective core networks 120a, 120b, such as a PCRF 134, HSS 132 and a PCEF/PGW 128 (not illustrated in FIG. 1E). In an embodiment, one or more of the DSCs 144a, 144b may be connected directly to one or more of the eNodeBs 116a, 116b.

In addition to the above-mentioned connections and communication links, the system 103 may include additional connections/links to accommodate data flows and communications between components in different E-UTRANs (e.g., E-UTRANS 140a and 140b). For example, the system 103 may include a connection/communication link between an eNodeB 116b in the second E-UTRAN 140b to an SGW 118 in the first E-UTRAN 140a. As another example, the system 103 may include a connection/communication link between a SGW 118 in the second E-UTRAN 140b to a PGW 128 in the first E-UTRAN 140a. To focus the discussion of the relevant embodiments, these additional components, connections, and communication links are not illustrated in FIG. 1E.

As is discussed in detail further below, the DSCs 144a, 144b may be configured to send information regarding the availability of spectrum resources (e.g., information received from an eNodeB, PCRF, PCEF, PGW, etc.) to the DPC 146. This information may include data relating to current and expected future usage and/or capacity of each network or sub-network. The DPC 146 may be configured to receive and use such information to intelligently allocate, transfer, manage, coordinate, or lease the available resources of the first E-UTRAN 140a to the second E-UTRAN 140b, and vice versa.

For example, the DPC 146 may be configured to coordinate the allocation of spectrum resources to the second E-UTRAN 140b (i.e., lessee network) from the E-UTRAN 140a (i.e., lessor network) as part of the dynamic spectrum arbitrage operations. Such operations may allow a wireless device 102 that is wirelessly connected to the eNodeB 116b in the second E-UTRAN 140b via a communication link 143 to be handed off to an eNodeB 116a in the first E-UTRAN 140a so that it may use the allocated spectrum resources of the first E-UTRAN 140a. As part of this handoff procedure, the wireless device 102 may establish a new connection 141 to the eNodeB 116a in the first E-UTRAN 140a, terminate the wireless connection 143 to the original eNodeB 116b, and use the allocated resources of the first E-UTRAN 140a as if they are included in the second E-UTRAN 140b. The DSA operations may be performed so that the first DSC 144a is a lessor DSC for a first resource/period of time, and a lessee DSC for a second resource or another period of time.

In an embodiment, the DSA and/or handoff operations may be performed so that the wireless device 102 maintains a data connection to (or a data connection that is managed by) the original network after it is handed off. For example, DSA and/or handoff operations may be performed so that the wireless device 102 maintains a dataflow connection to a PGW 128 in the second E-UTRAN 140b after being handed off to the eNodeB 116a in the first E-UTRAN 140a.

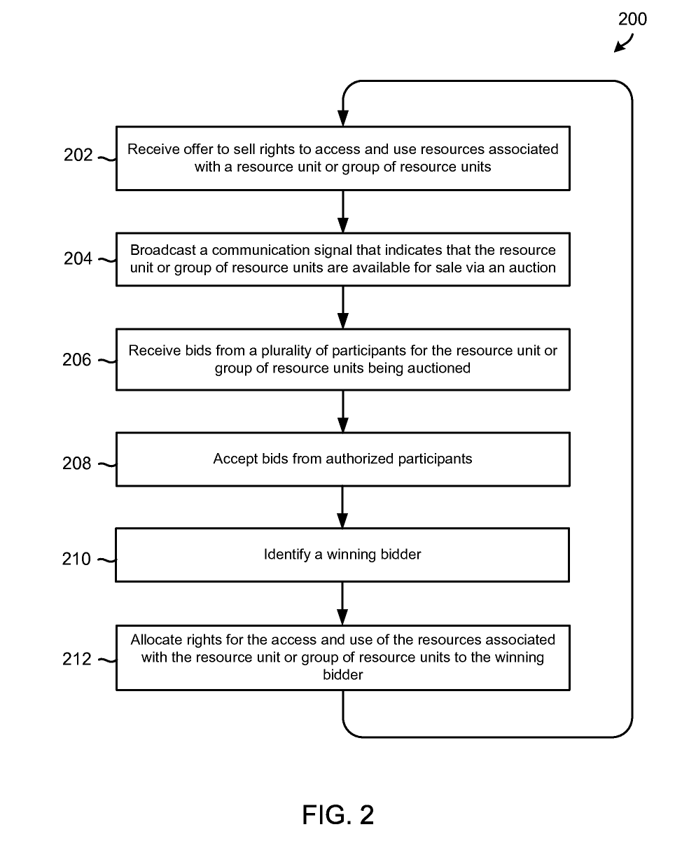

FIG. 2 illustrates an DSA method 200 of auctioning a resource unit or group of resource unit in accordance with an embodiment. The operations of DSA method 200 may be performed by a processor or processing core in a DPC 146 component, in a TCE component, or a combination thereof. In description below, DSA method 200 may be performed by a processing core in a DPC 146 component, which may include a TCE component.

In operation 202, the DPC 146 may receive offer for the sale of a resource unit or group of resource units, and an asking price for the offered resource unit or group of resource units. In operation 204, the DPC 146 may broadcast a communication signal that includes information suitable for informing a plurality of potential auction participants that the offered resource unit or group of resource units are available for sale and of the asking price for the resource unit or group of resource units. In operation 206, the DPC 146 may receive bids from a plurality of participants (e.g., telecommunication networks, investors, etc.) for the resource unit or group of resource units. In operation 208, the DPC 146 may accept only the bids received from authorized participants determined to be eligible to participate in the auction. For example, as part of operation 206, the DPC 146 may determine whether the participants are registered brokers that are authorized to participate in the resource auction, and accept only the bids that are received from these authorized participants.

In operation 210, the DPC 146 may identify a winning bidder, such as by identifying the participant that submitted the last or highest bid for the current or future right to access and use resources associated with the resource unit or group of resource units. In operation 212, the DPC 146 may allocate the rights for the current or future access and use of the resources to the winning bidder. In an embodiment, this may accomplished by recording a transaction in a transaction database identifying the participant that submitted the winning bid as owning the resource units and/or having exclusive rights to the access and use of the resources associated with the resource units at a current or future date or time.

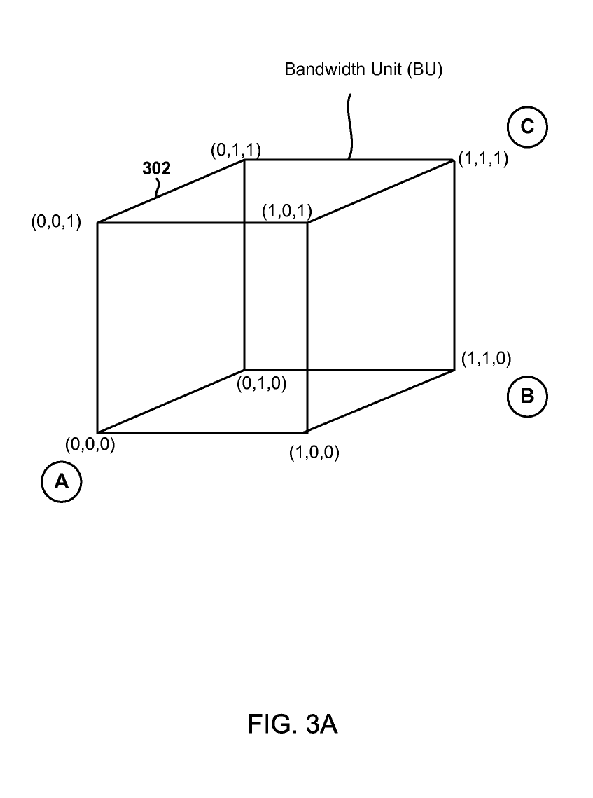

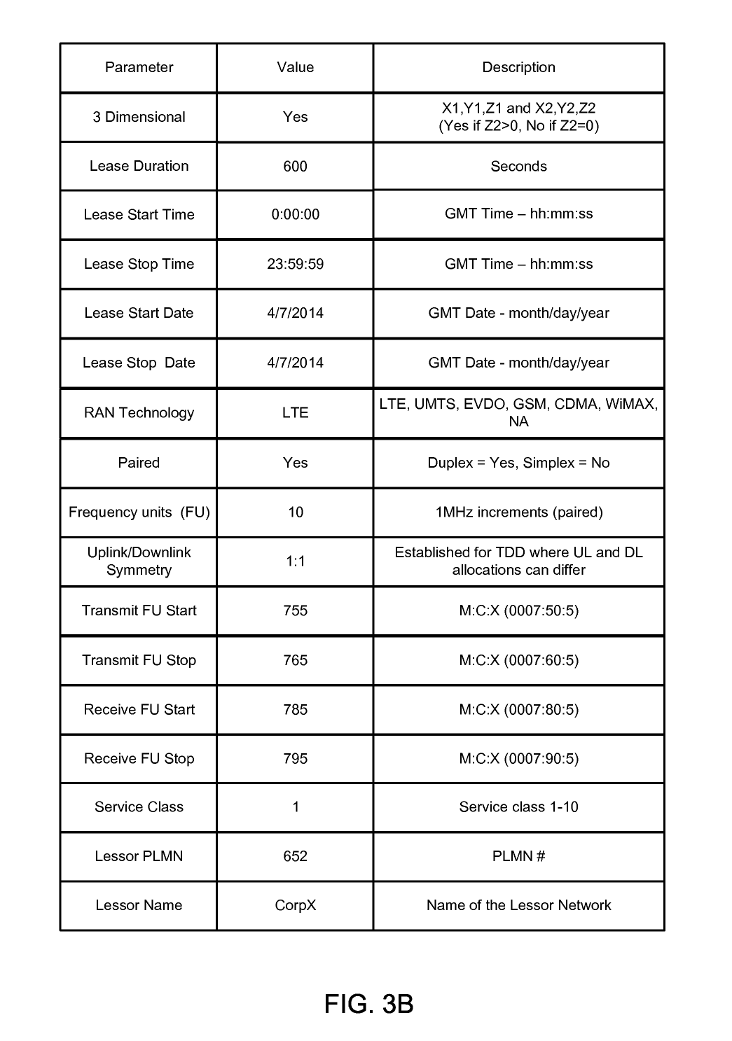

FIG. 3A is an illustration of an embodiment resource unit 302 in the form of a bandwidth unit (BU) or bandwidth unit cube (BU cube) that defines an amount of bandwidth (e.g., 100 megabits/second) in relation to a well-defined resource boundary in the form of a three dimensional cube. The BU cube's dimensions may be 1 m×1 m×1 m, 1 km×1 km×1 km, 10 ps×10 ps×10 ps, or any other similar dimension. The BU cube may be defined based on two fundamental points (X₁, Y₁, Z₁)-(X₂, Y₂, Z₂). In the example illustrated in FIG. 3A, the BU cube includes three dimensional points (A, B, and C), which are defined at points (0, 0, 0), (1, 1, 0), and (1, 1, 1), respectively.

The BU (or BU cube) may identify, define, quantify, pool, partition, organize, and/or package one or more telecommunication resources (e.g., an amount of bandwidth, etc.) into a well-defined, granular, discrete, standardized, and/or fungible unit that is well suited for comparison and/or mutual substitution. The BU may also include information that is suitable for identifying various characteristics and/or properties of the telecommunications resource or resource offering, such as the radio access network technologies that are supported or compatible with the offered resource or network, the geographic area(s) in which the resource is offered for use, a resource availability time or date, a resource expiration time, a lease duration, lease start and stop times or dates, a pairing status, frequency units (FUs), an uplink/downlink symmetry value or ratio, transmit/receive frequency unit start and stop values, the service class of the resource or offering, the public land mobile network (PLMN) identifier of the lessor network offering the resource, etc.

FIG. 3B is an illustration of table that may be stored in association with a BU to identify these characteristics or properties. The table illustrated in FIG. 3B lists the properties/characteristics as parameter-value pairs, and includes a description field that provides additional information for each parameter. The parameters be different for different types of telecommunication resources. In some embodiments, the table may be stored in a database that is accessible to one or more DSA components in the DSA system, such as the TCE component, DPC component, etc.

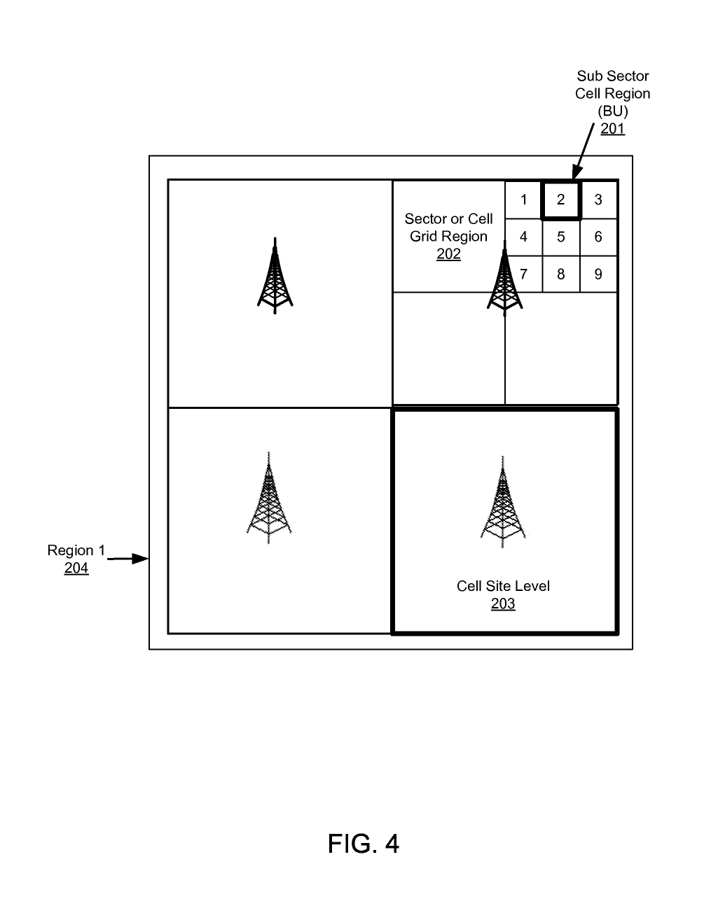

FIG. 4 is an illustration of various geographical boundaries associated with a telecommunication resource that may be represented by one or more resource units in accordance with the various embodiments. Specifically, FIG. 4 illustrates that the geographical boundaries of a resource may be represented via single BU (201) or multiple BUs that define a sector of cell (202), a whole cell (203), or which represent multiple cells (204).

Each BU cube may represent the most granular geospatial area of commoditized telecommunication broadband resource. Each BU cube may include, identify or represent an X amount of a telecommunication resource (e.g., bandwidth). BU cubes may be aggregated into larger cubes or forms within polygons or groups of polygons, and used as a multi-dimensional artillery grid by which those seeking resources may identify and select target areas, and as necessary, adjust onto their specific optimum target area.

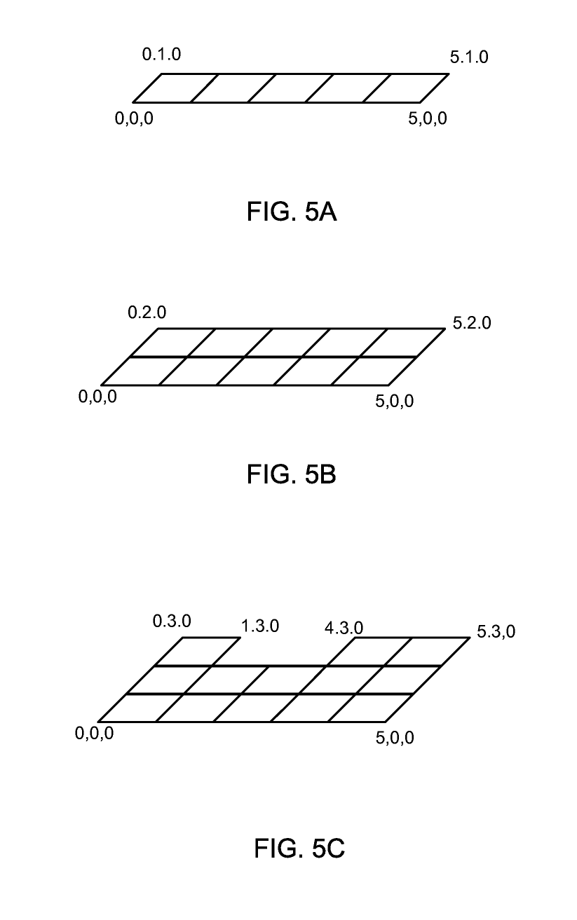

FIGS. 5A and 5B illustrate that resource units may be combined to define polygons that cover different geographical areas. FIG. 5C illustrates that resource units may combined or arranged so as to form an irregular shape. This flexibility provides participants with fine grain controls over the resources they offer, lease or purchase. Such fine grain controls allow lessee networks to purchase or lease only the resources they require or are likely to use. These fine grain controls also allow lessor networks to more narrowly slice their available resources so that they may be leased to more consumers or so that they may be priced more competitively.

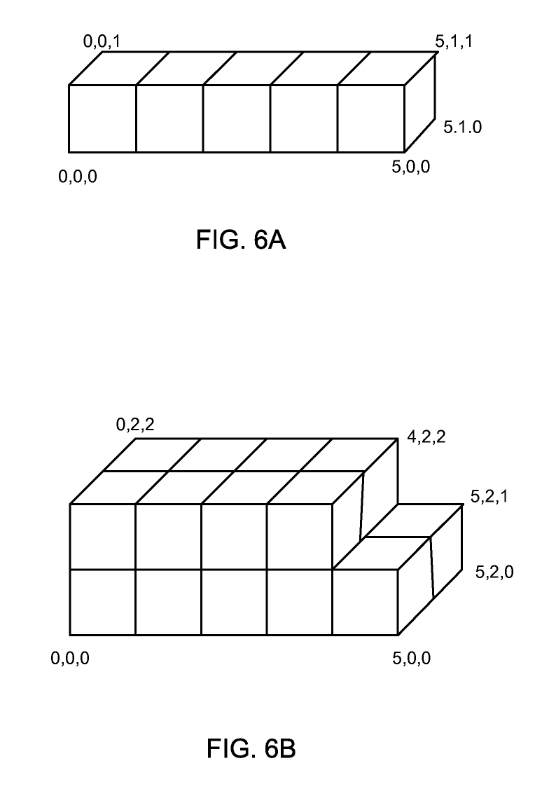

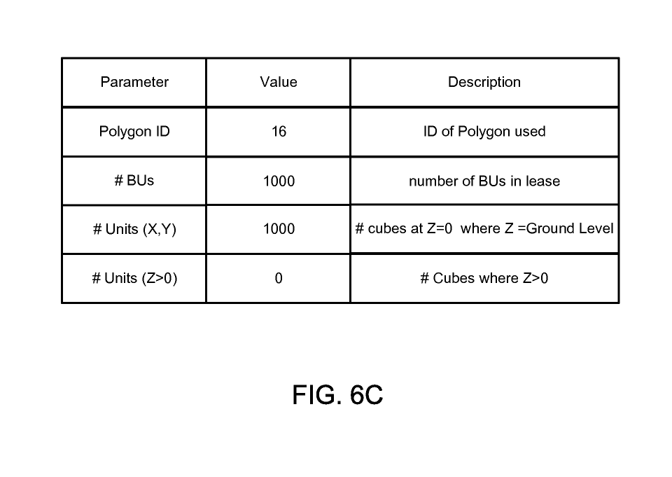

FIGS. 6A and 6B illustrate that resource cubes (i.e., resource units that include a Z, height, or altitude component) may be combined or grouped to define polygons that cover different geographical areas. The Z, height, or altitude component of the resource cubes may be defined in relation to the mean sea level (MSL) or the above ground level (AGL). For example, altitude component may be defined relative to 100 meters above the mean sea level.

FIG. 6C is an illustration of table that may be stored in association with a BU grouping that defines polygon to identify various properties of the grouping or the BUs that are included in the group. The table illustrated in FIG. 6C lists the properties as parameter-value pairs, and includes a description field that provides additional information for each parameter. The parameters include a polygon ID, number of BUs included in the grouping, number of BUs that define an area in terms of length and width, and number of BUs that include a value for the Z, height, or altitude component of the area. In the example illustrated in FIG. 6C, the BU grouping has a Polygon ID of 16 and includes 1000 BUs. All the included BUs define an area in terms of length and width, and none of the included BUs include Z, height, or altitude component. That is, all of the included BUs are associated with two-dimensional resource boundaries.

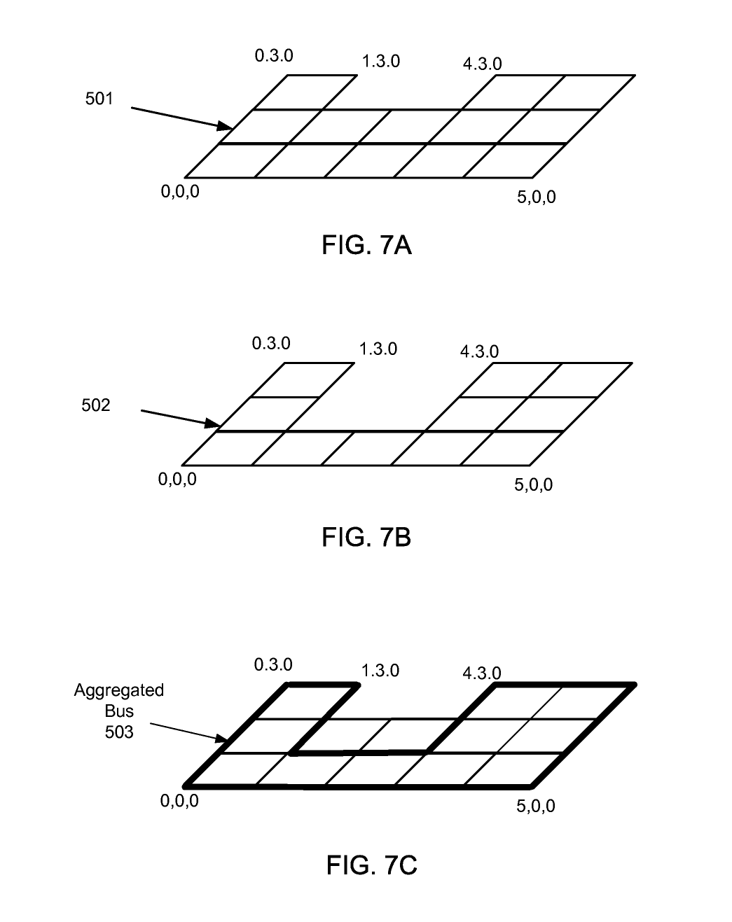

FIGS. 7A and 7B are illustrations of different resource unit groupings that share common geodetic reference points in accordance with an embodiment. FIG. 7C illustrates that the resource unit groupings illustrated in FIGS. 7A and 7B may be aggregated to increase the availability of the telecommunication resource. This aggregation may be accomplished by utilizing a radio resource allocation scheme, and may include overlapping polygons and aggregating resource units that have different frequency bands, bandwidth allocations, or service classes.

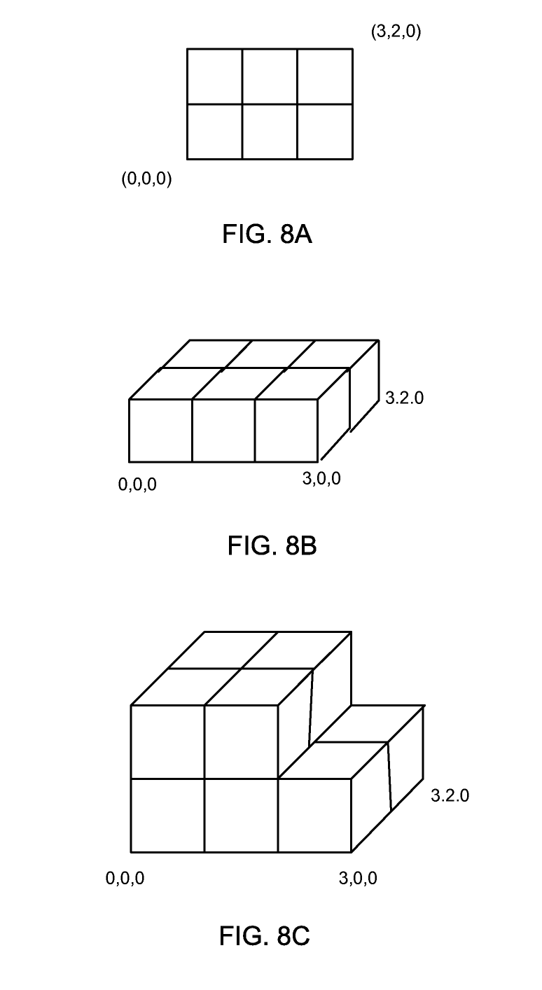

FIGS. 8A-8C are illustrations of different resource unit groupings in accordance with an embodiment. Specifically, FIG. 8A illustrates a resource unit grouping in the form of a primary polygon that is defined with a representative number of resource units. FIGS. 8B and 8C illustrates resource cube groupings corresponding to the primary polygon illustrated in FIG. 8A and which form a polygon having a Z, height, or altitude component.

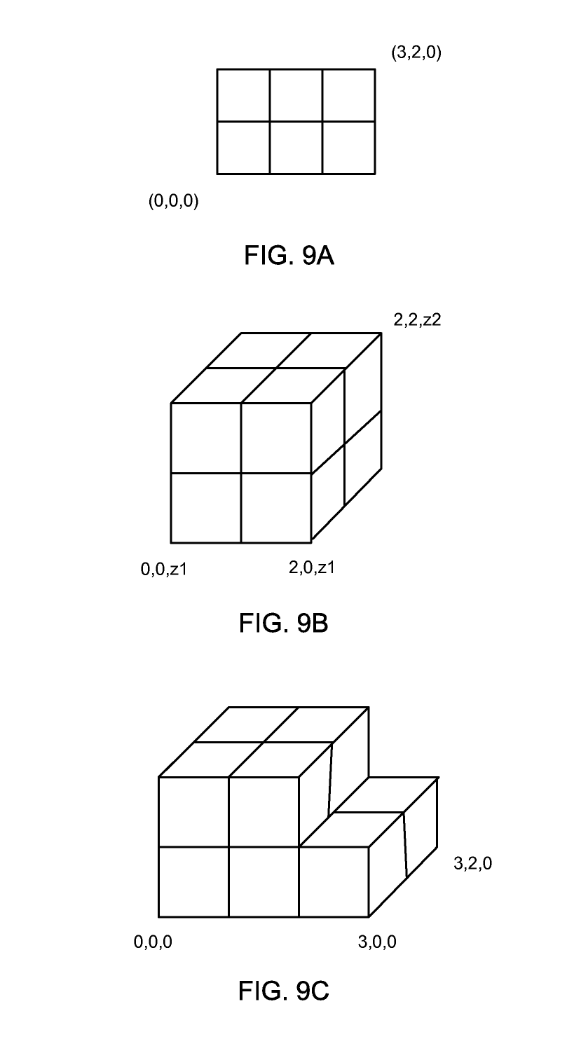

FIGS. 9A-9C are illustrations of different resource unit groupings in accordance with another embodiment. FIG. 9A illustrates a resource unit grouping in the form of a primary polygon that is defined with a representative number of resource units. FIGS. 9B and 9C illustrates resource cube groupings corresponding to the primary polygon illustrated in FIG. 9A and which form a polygon having a Z, height, or altitude component. FIGS. 9B and 9C also illustrate that the resource cube groups do not have to be contiguous in any direction, and may include a height, length or width variance or gag between the resource units.

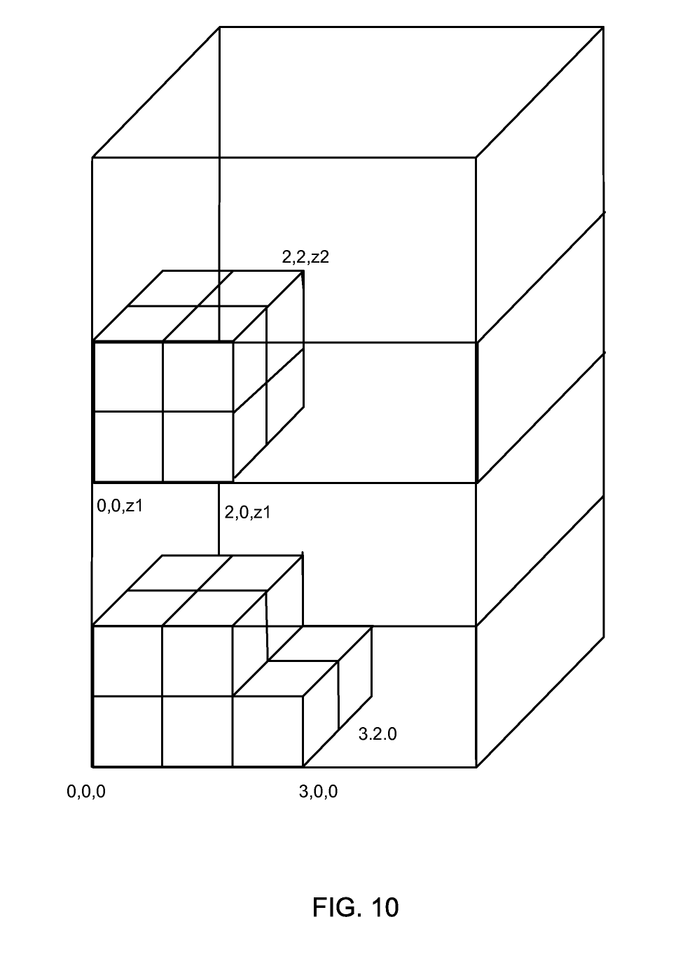

FIG. 10 is an illustration that shows the resource cubes being associated with floors in a building in accordance with an embodiment. That is, different floors in the building are designated with different resource cube combinations or grouping. The locations of the resource cubes may also be associated with negative Z axis, which may include areas of the polygons that are below grade, such as parking facilities or basements. The two cube clusters/grouping illustrated in FIG. 10 do not have to be coupled, and it is possible that the particular attributes associated with the different resource cube groupings share a common polygon but have different attributes leading to different telecommunication resource allocations based on the number of resource cubes and their relative position in terms of altitude, Z, to the primary polygon (e.g., the polygon illustrated in FIG. 9A).

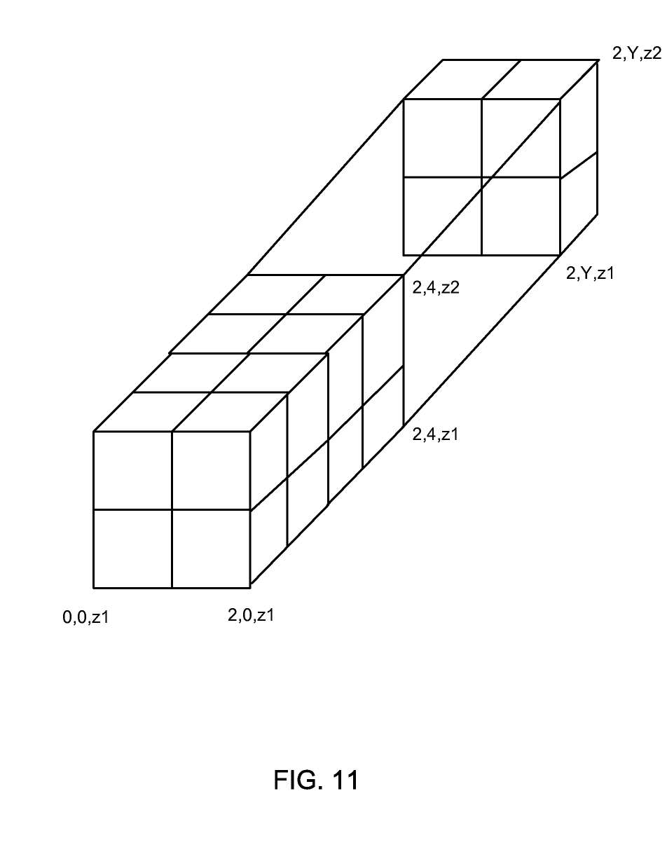

FIG. 11 illustrates that the resource cubes may be grouped to cover corridors and other similar areas. Specifically, FIG. 11 illustrates a resource group/cluster that includes resource cubes that include an altitude and which extend for a distance Y.

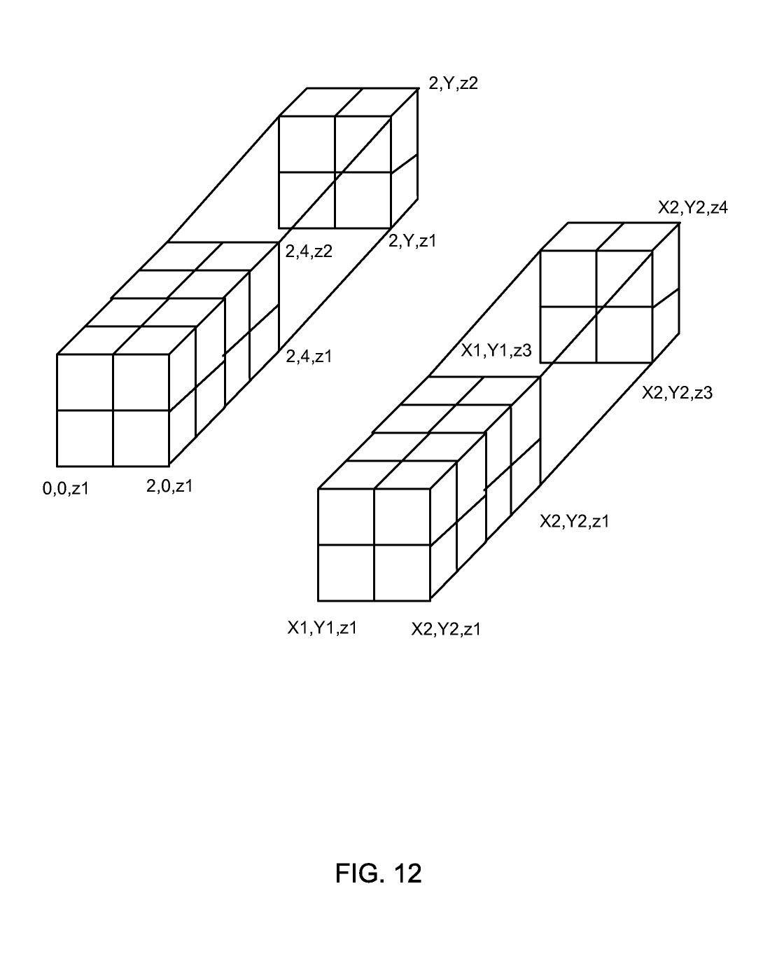

FIG. 12 illustrates that the resource cubes may be grouped to cover lanes in a highway, bridges and other similar areas. Such a corridor cluster could cover or target mobility traffic involving radio resources, such as the George Washington Bridge during peak hours of usage. That is, at certain times of the day, cell cites and servers come into an over abundance of data necessities from commuters going in and out of New York City. Service providers interested in covering this zone are may want to bid on the exact area where the bridge is, and using certain grid allocation techniques, the various embodiments may allow for bidding on resources for the inbound upper and lower deck of the bridge for morning rush hour and then only looking for resources for the outbound lower deck for the bridge during the evening rush hour.

With the resource cubes the need for a common geodetic reference is needed to not only facilitate the potential bidder's ability to determine the viability of an offered polygon but also enable corridor clusters as well as use of telecommunication resources in multiple tiers of elevation. There are multiple ways of dissecting the planet Earth into grids for determining locations, and some are more useful and accurate than others. Using the latitude and longitude coordinate system for defining some of the resource cube dimensions would be a mistake differing sizes that the resource cube may have as latitude changes due the earth's curvature.

One method is a system called The Universal Transverse Mercator System, better known as “UTM.” There are other coordinate systems like the National Coordinate Systems including Spatial Reference Systems (SRS) or the Coordinate Reference System (CRS) that can be used as well. However for this example UTM will be used.

The UTM system divides the earth into 60 separate zones of six degrees of longitude each. Also, the earth is separated and labeled A to Z, in respect to latitude. The latitude division of the earth gives each section eight degrees of width, with a few exceptions. Letters I and O are not used to avoid confusion as they are written similarly to numbers. Sections A and B take up the southern eighty degrees of the globe, and Y and Z take up the northern eighty four degrees, so these sections cover the poles, the areas that make the latitude and longitude system nearly unusable, creating an amount of distortion that would only be detrimental to defining a BU cube. In addition, zone X in the UTM system encompasses twelve degrees of latitude rather than the standard eight thereby making it's a better coordinate system to utilize.

With this system of creating exact, and useful grids of the planet earth, creating a location of an exact point on a two dimensional field becomes quite simple. If you are aware of which grid you are located in, you can use X and Y coordinates to determine how far in the X direction and the Y direction a certain location is in relation to the grid that you have picked. So going back to the George Washington Bridge, you can use UTM to determine the exact location of the bridge, or truly, the exact area that you would like to provide coverage to. Using UTM, you can determine the beginning and end X and Y coordinates, and get as accurate and precise measurement as you would want.

Using UTM, the earth is already divided into equal sized areas, with a handful of oddball spots as you approach the northern and southern poles. This means we can create a standard unit of measure of space, and determine its exact location by using UTM coordinates. For example, let's say we were to create a standard unit of a square meter. For the George Washington Bridge, if you had the coordinates for the start and end of the bridge, you can divide the determined area into square meter blocks, and auction off those in groups or individually, depending on who is leasing the resources.

We can make how we divide resources even more granular however, and more effective and useful. There are two levels to the George Washington Bridge, and a service provider may only be interested in covering the upper level. The UTM grid system would work well for helping determine the X and Y coordinates. However UTM does not have a Z coordinate. Therefore Z coordinate may be referenced to many points. The most common reference point is relative to sea level, average mean above sea level (AMSL). Determining the Z coordinates in relation to sea level may give a universal point of “Zero” for the Z axis. Being able to use the Z axis in determining coverage areas may help the DSA components determine more exact prices of coverage for certain areas, such as high rise apartment buildings in cities. Coverage at certain heights of the building may be worth more to certain people than others, and having the ability to choose the height of a unit of coverage makes that possible.

By adding in the third directional coordinates, the DSA component may modify our use of a basic unit of coverage from being a square meter to a meter cubed leading to the BU cube. Therefore being able to divide the George Washington Bridge, or any other trafficked area, into a definitive amount of purchasable coverage blocks may help unify the way BUs are generated, used and defined.

The various embodiments include dynamic spectrum arbitrage (DSA) methods and components configured to implement the DSA methods. A DSA method may include generating granular resource units that each identify an amount of a telecommunication resource that is offered for allocation and use by other networks with respect to an area or volume, and offering the resource units for purchase, lease, or trade on a commodities exchange.

In an embodiment, generating the granular resource units may include generating resource units that use a universal standard to identify, quantify, measure, and/or represent the telecommunication resource. In an embodiment, generating the granular resource units may include generating resource units that identify the telecommunication resource in a standard format, structure, or unit that is readily understood by the trading community. In an embodiment, generating the granular resource units may include generating resource units that include or provide a common reference point against which other resource units and telecommunication resources may be compared. In an embodiment, generating the granular resource units may include generating resource units that define an amount of bandwidth in relation to a geographic area encompassing one cubic meter. In an embodiment, generating the granular resource units may include generating resource units that may be combined to cover a precise location or area.

In an embodiment, the DSA method may include comparing two or more resource units that represent different resource offerings from different networks to determine the relative economic value of the offered amounts of telecommunication resource. In an embodiment, the DSA method may include combining the resource units to cover an area that encompasses a highway, bridge, navigation path, waterway, air traffic corridor, and/or any other similar area. In an embodiment, the resource units may be resource cubes that include an altitude dimension. In an embodiment, the DSA method may include combining the resource units to cover one or more floors of an office building. In an embodiment, offering the resource units for purchase, lease, or trade on a commodities exchange may include grouping the resource units to form a polygon and offering the group of resource units for purchase, lease, or trade on the commodities exchange.

Further embodiments may include a server computing device having a multi-core processor that includes two or more processor cores, one or more of which is configured with processor-executable instructions to perform operations of the DSA methods described above. Further embodiments may include a server computing device having various means for performing functions of the operations of the DSA methods described above. Further embodiments may include non-transitory processor-readable storage medium having stored thereon processor-executable instructions to cause a processor to perform operations of the DSA methods described above.

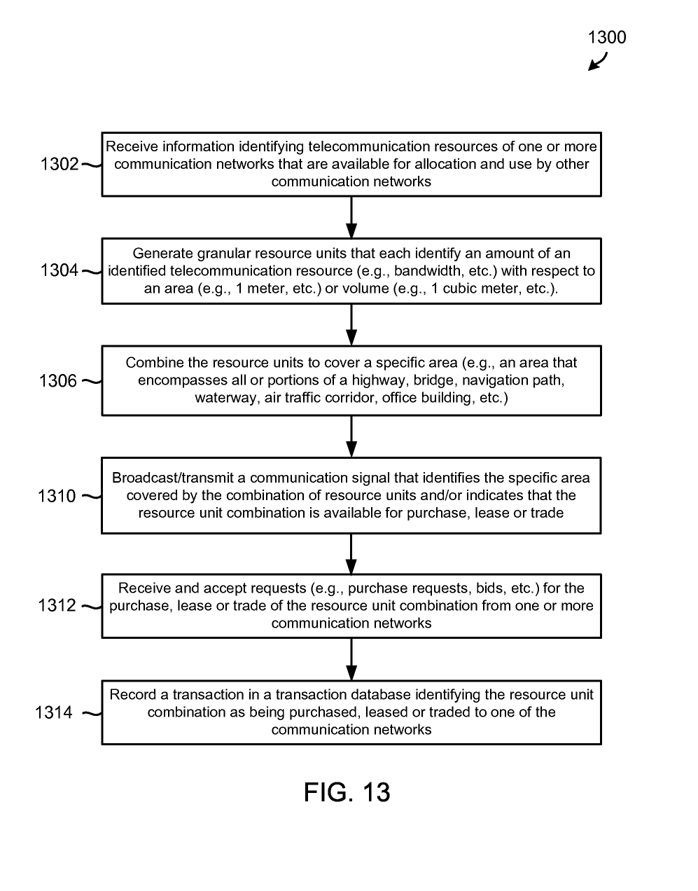

FIG. 13 illustrates DSA method 1300 of generating and using resource units in accordance with an embodiment. DSA method 1300 may be performed by one or more processors of one or more server computing devices that implement all or portions of a DSA component, such as a computing device that implements a DPC component, TCE component, DSC component, etc. In block 1302, a processor of a DSA component may receive information identifying telecommunication resources of one or more communication networks that are available for allocation and use by other communication networks. In block 1304, the processor may generate granular resource units that each identify an amount of an identified telecommunication resource (e.g., bandwidth, etc.) with respect to an area (e.g., 1 meter, etc.) or volume (e.g., 1 cubic meter, etc.).

In block 1306, the processor may combine the resource units to cover a specific area (e.g., an area that encompasses all or portions of a highway, bridge, navigation path, waterway, air traffic corridor, office building, etc.). In block 1308, the processor may broadcast/transmit a communication signal that identifies the specific area covered by the combination of resource units and/or indicates that the resource unit combination is available for purchase, lease or trade. In block 1310, the processor may receive and accept requests (e.g., purchase requests, bids, etc.) for the purchase, lease or trade of the resource unit combination from one or more communication networks. In block 1312, the processor may record a transaction in a transaction database identifying the resource unit combination as being purchased, leased or traded to one of the communication networks.

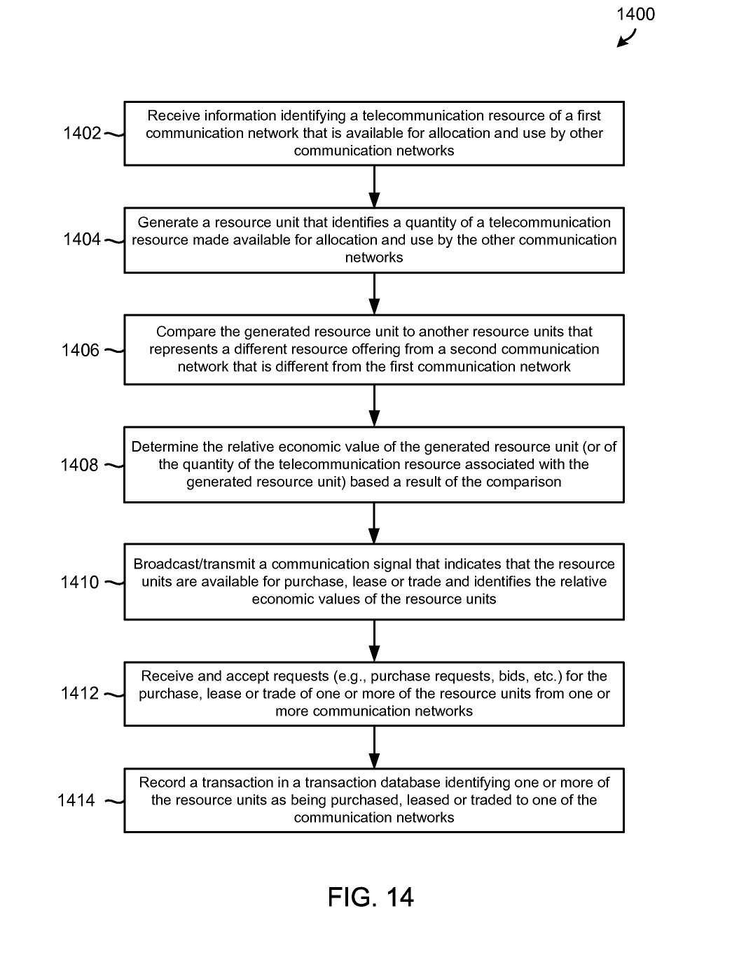

FIG. 14 illustrates DSA method 1400 of generating and using resource units in accordance with another embodiment. DSA method 1400 may be performed by one or more processors or processing cores in one or more server computing devices that implement all or portions of a DSA component, such as a computing device that implements a DPC component or TCE component. In block 1402, a processor of a DSA component may receive information identifying a telecommunication resource of a first communication network that is available for allocation and use by other communication networks. In block 1404, the processor may generate a resource unit that identifies a quantity of a telecommunication resource made available for allocation and use by the other communication networks. In block 1406, the processor may compare the generated resource unit to another resource units that represents a different resource offering from a second communication network that is different from the first communication network. In block 1408, the processor may determine the relative economic value of the generated resource unit (or of the quantity of the telecommunication resource associated with the generated resource unit) based a result of the comparison.

In block 1410, the processor may broadcast/transmit a communication signal that indicates that the resource units are available for purchase, lease or trade and identifies the relative economic values of the resource units. In block 1412, the processor may receive and accept requests (e.g., purchase requests, bids, etc.) for the purchase, lease or trade of one or more of the resource units from one or more communication networks. In block 1414, the processor may record a transaction in a transaction database identifying one or more of the resource units as being purchased, leased or traded to one of the communication networks.

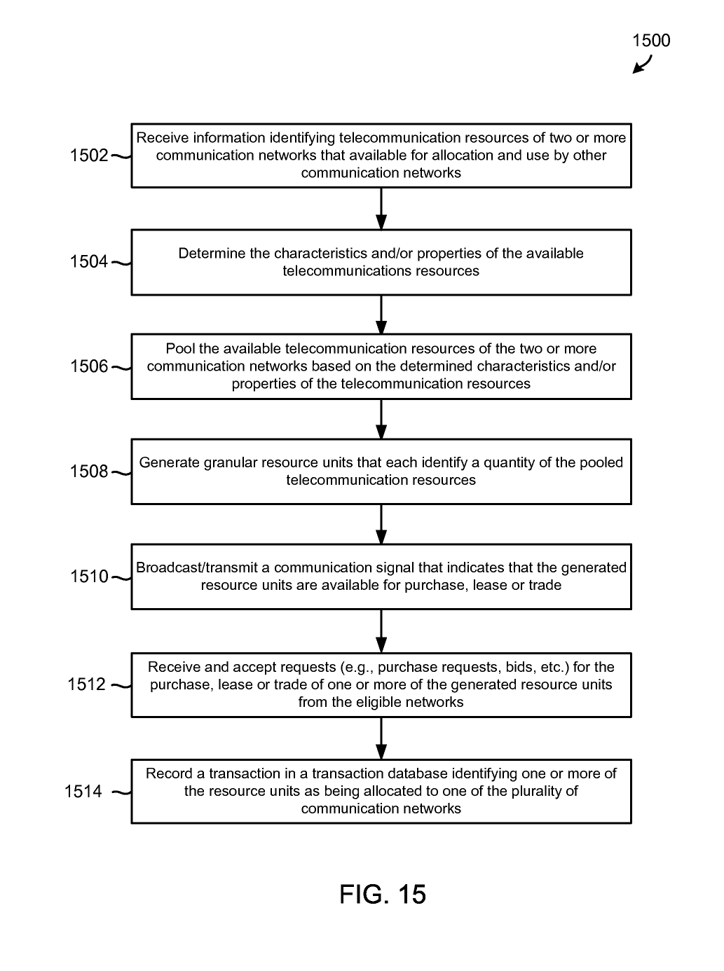

FIG. 15 illustrates DSA method 1500 of generating and using resource units in accordance with another embodiment. DSA method 1500 may be performed by one or more processors or processing cores in one or more server computing devices that implement all or portions of a DSA component, such as a computing device that implements a DPC component or TCE component. In block 1502, a processor of a DSA component may receive information identifying telecommunication resources of two or more communication networks that available for allocation and use by other communication networks. In block 1504, the processor may determine the characteristics and/or properties of the available telecommunications resources. In block 1506, the processor may pool the available telecommunication resources of the two or more communication networks based on the determined characteristics and/or properties of the telecommunication resources.

In block 1508, the processor may generate granular resource units that each identify a quantity of the pooled telecommunication resources. In block 1510, the processor may broadcast/transmit a communication signal that indicates that the generated resource units are available for purchase, lease or trade. In block 1512, the processor may receive and accept requests (e.g., purchase requests, bids, etc.) for the purchase, lease or trade of one or more of the generated resource units from the eligible networks. In block 1514, the processor may record a transaction in a transaction database identifying one or more of the resource units as being allocated to one of the plurality of communication networks.

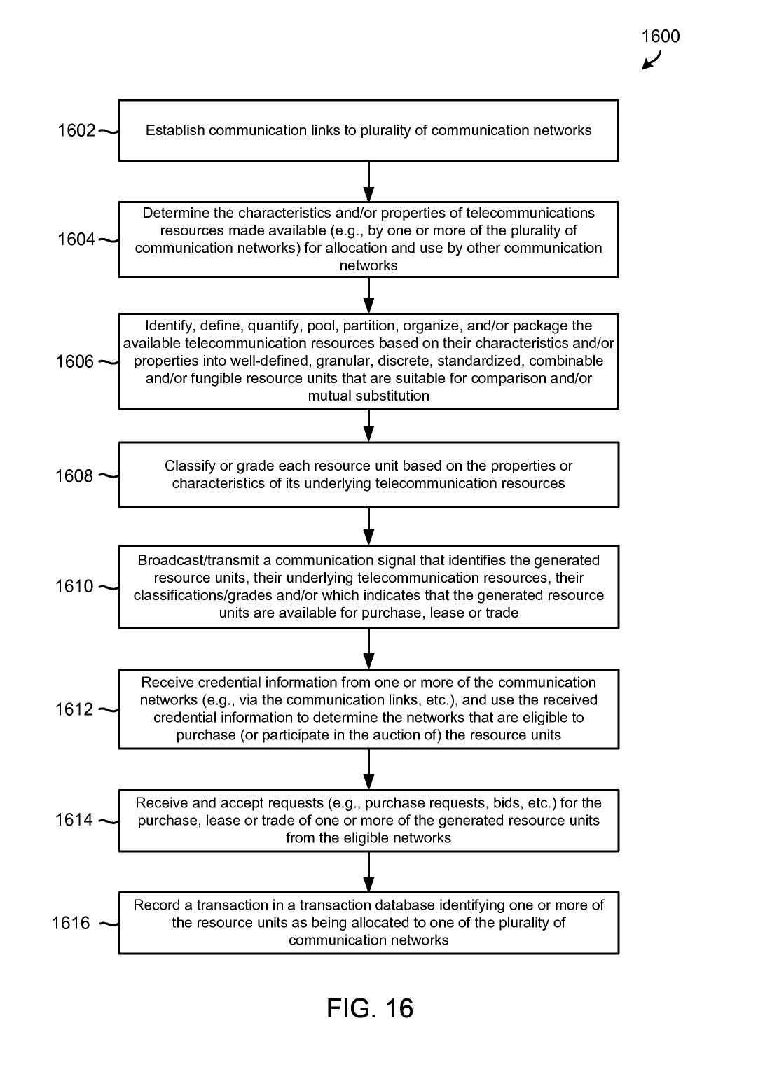

FIG. 16 illustrates DSA method 1600 of generating and using resource units in accordance with another embodiment. DSA method 1600 may be performed by one or more processors or processing cores in one or more server computing devices that implement all or portions of a DSA component, such as a computing device that implements a DPC component or TCE component. In block 1602, a processor of a DSA component may establish communication links to plurality of communication networks. In block 1604, the processor may determine the characteristics and/or properties of telecommunications resources made available (e.g., by one or more of the plurality of communication networks) for allocation and use by other communication networks.

In block 1606, the processor may identify, define, quantify, pool, partition, organize, and/or package the available telecommunication resources based on their characteristics and/or properties into well-defined, granular, discrete, standardized, combinable and/or fungible resource units that are suitable for comparison and/or mutual substitution. In block 1608, the processor may classify or grade each resource unit based on the properties or characteristics of its underlying telecommunication resources. In block 1610, the processor may broadcast/transmit a communication signal that identifies the generated resource units, their underlying telecommunication resources, their classifications/grades and/or which indicates that the generated resource units are available for purchase, lease or trade. In block 1612, the processor may receive credential information from one or more of the communication networks (e.g., via the communication links, etc.), and use the received credential information to determine the networks that are eligible to purchase (or participate in the auction of) the resource units. In block 1614, the processor may receive and accept requests (e.g., purchase requests, bids, etc.) for the purchase, lease or trade of one or more of the generated resource units from the eligible networks. In block 1616, the processor may record a transaction in a transaction database identifying one or more of the resource units as being allocated to one of the plurality of communication networks.

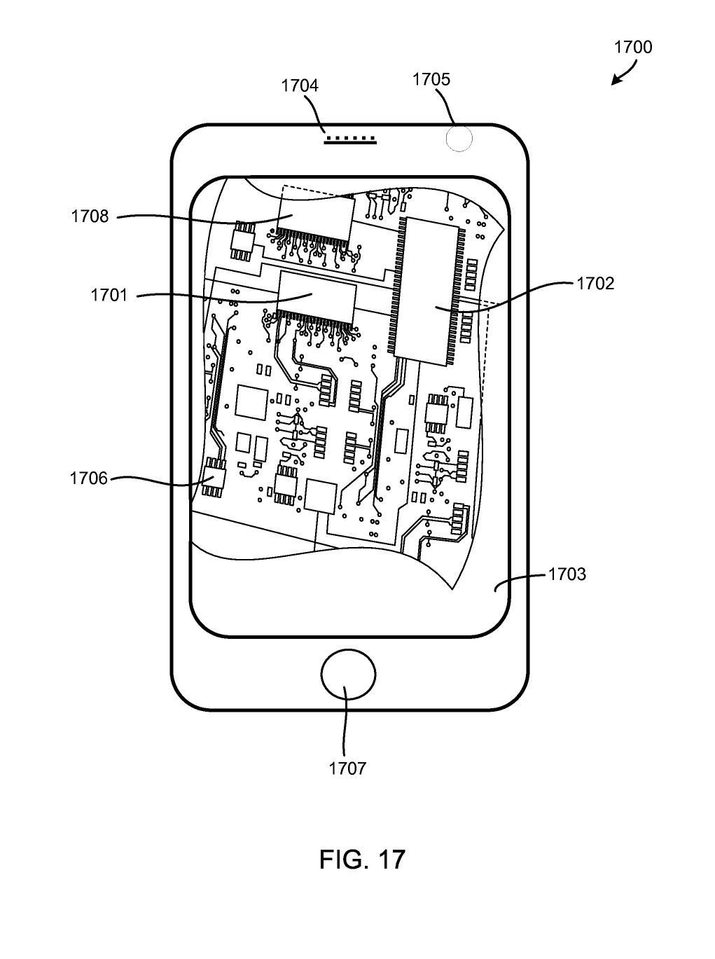

Various embodiments may be implemented on a variety of mobile wireless computing devices, an example of which is illustrated in FIG. 17. Specifically, FIG. 17 is a system block diagram of a mobile transceiver device in the form of a smartphone/cell phone 1700 suitable for use with any of the embodiments. The cell phone 1700 may include a processor 1701 coupled to internal memory 1702, a display 1703, and to a speaker 1704. Additionally, the cell phone 1700 may include an antenna 1705 for sending and receiving electromagnetic radiation that may be connected to a wireless data link and/or cellular telephone transceiver 1706 coupled to the processor 1701. Cell phones 1700 typically also include menu selection buttons or rocker switches 1707 for receiving user inputs.

A typical cell phone 1700 also includes a sound encoding/decoding (CODEC) circuit 1708 which digitizes sound received from a microphone into data packets suitable for wireless transmission and decodes received sound data packets to generate analog signals that are provided to the speaker 1704 to generate sound. Also, one or more of the processor 1701, wireless transceiver 1706 and CODEC 1708 may include a digital signal processor (DSP) circuit (not shown separately). The cell phone 1700 may further include a ZigBee transceiver (i.e., an IEEE 802.15.4 transceiver) for low-power short-range communications between wireless devices, or other similar communication circuitry (e.g., circuitry implementing the Bluetooth® or WiFi protocols, etc.).

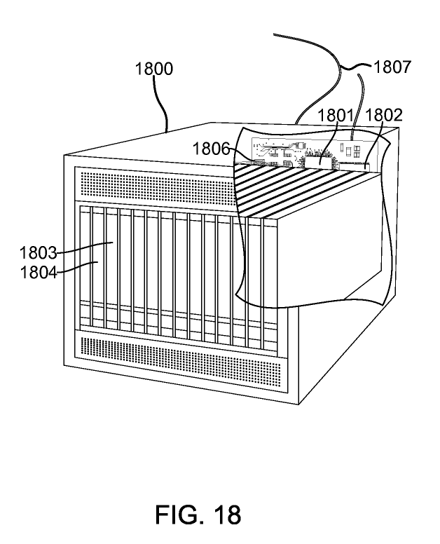

The embodiments described above, including the DSA and spectrum arbitrage functions, may be implemented on any of a variety of commercially available server devices, such as the server 1800 illustrated in FIG. 18. Such a server 1800 typically includes a processor 1801 coupled to volatile memory 1802 and a large capacity nonvolatile memory, such as a disk drive 1803. The server 1800 may also include a floppy disc drive, compact disc (CD) or DVD disc drive 1804 coupled to the processor 1801. The server 1800 may also include network access ports 1806 coupled to the processor 1801 for establishing data connections with a network 1807, such as a local area network coupled to other communication system computers and servers.

The processors 1701, 1801, may be any programmable microprocessor, microcomputer or multiple processor chip or chips that can be configured by software instructions (applications) to perform a variety of functions, including the functions of the various embodiments described below. In some wireless devices, multiple processors 1801 may be provided, such as one processor dedicated to wireless communication functions and one processor dedicated to running other applications. Typically, software applications may be stored in the internal memory 1702, 1802, before they are accessed and loaded into the processor 1701, 1801. The processor 1701, 1801 may include internal memory sufficient to store the application software instructions. In some servers, the processor 1801 may include internal memory sufficient to store the application software instructions. In some receiver devices, the secure memory may be in a separate memory chip coupled to the processor 1701. The internal memory 1702, 1802 may be a volatile or nonvolatile memory, such as flash memory, or a mixture of both. For the purposes of this description, a general reference to memory refers to all memory accessible by the processor 1701, 1801, including internal memory 1702, 1802, removable memory plugged into the device, and memory within the processor 1701, 1801 itself.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the embodiments disclosed herein may be implemented or performed with a general purpose processor, a digital signal processor (DPC), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine A processor may also be implemented as a combination of computing devices, e.g., a combination of a DPC and a microprocessor, a plurality of microprocessors, one or more microprocessors in conjunction with a DPC core, or any other such configuration. Alternatively, some steps or methods may be performed by circuitry that is specific to a given function.

In one or more exemplary embodiments, the functions described may be implemented in hardware, software, firmware, or any combination thereof. If implemented in software, the functions may be stored as one or more instructions or code on a non-transitory computer-readable medium or non-transitory processor-readable medium. The steps of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A dynamic spectrum arbitrage (DSA) method, comprising:
generating granular resource units that each identify an amount of a telecommunication resource that is offered for allocation and use by other networks with respect to an area or volume; and
offering the resource units for purchase, lease, or trade on a commodities exchange.

2. The DSA method of claim 1, wherein generating the granular resource units comprises generating resource units that use a universal standard to identify, quantify, measure, and represent the telecommunication resource.

3. The DSA method of claim 1, wherein generating the granular resource units comprises generating resource units that identify the telecommunication resource in a standardized format and structure.

4. The DSA method of claim 1, wherein generating the granular resource units comprises generating resource units that include a common reference point that is suitable for use in comparing the granular resource units against other resource units.

5. The DSA method of claim 4, further comprising:
comparing two or more resource units that represent different resource offerings from different networks to determine the relative economic value of the offered amounts of telecommunication resource.

6. The DSA method of claim 1, wherein generating the granular resource units comprises generating resource units that define an amount of bandwidth in relation to a geographic area encompassing one cubic meter.

7. The DSA method of claim 1, wherein generating the granular resource units comprises generating resource units that may be combined to cover a well-defined area.

8. The DSA method of claim 7, further comprising:
combining the resource units to cover an area that encompasses one of a highway portion, a bridge, a navigation path, a waterway portion, and air traffic corridor.

9. The DSA method of claim 7, wherein the resource units are resource cubes that include an altitude dimension, the method further comprising:
combining the resource units to cover one or more floors of an office building.

10. The DSA method of claim 1, wherein offering the resource units for purchase, lease, or trade on a commodities exchange comprises:
grouping the resource units to form a polygon; and
offering the group of resource units for purchase, lease, or trade on the commodities exchange.

11. A server computing device, comprising:
a processor configured with processor-executable instructions to perform operations comprising:
generating granular resource units that each identify an amount of a telecommunication resource that is offered for allocation and use by other networks with respect to an area or volume; and
offering the resource units for purchase, lease, or trade on a commodities exchange.

12. The server computing device of claim 11, wherein the processor is configured with processor-executable instructions to perform operations such that generating the granular resource units comprises generating resource units that use a universal standard to identify, quantify, measure, and represent the telecommunication resource.

13. The server computing device of claim 11, wherein the processor is configured with processor-executable instructions to perform operations such that generating the granular resource units comprises generating resource units that identify the telecommunication resource in a standardized format and structure.

14. The server computing device of claim 11, wherein the processor is configured with processor-executable instructions to perform operations such that generating the granular resource units comprises generating resource units that include a common reference point that is suitable for use in comparing the granular resource units against other resource units.

15. The server computing device of claim 14, wherein the processor is configured with processor-executable instructions to perform operations further comprising:
comparing two or more resource units that represent different resource offerings from different networks to determine the relative economic value of the offered amounts of telecommunication resource.

16. The server computing device of claim 11, wherein the processor is configured with processor-executable instructions to perform operations such that generating the granular resource units comprises generating resource units that define an amount of bandwidth in relation to a geographic area encompassing one cubic meter.

17. The server computing device of claim 11, wherein the processor is configured with processor-executable instructions to perform operations such that generating the granular resource units comprises generating resource units that may be combined to cover a well-defined area.

18. The server computing device of claim 17, wherein the processor is configured with processor-executable instructions to perform operations further comprising:
combining the resource units to cover an area that encompasses one of a highway portion, a bridge, a navigation path, a waterway portion, and air traffic corridor.

19. The server computing device of claim 17, wherein the processor is configured with processor-executable instructions to perform operations such that the resource units are resource cubes that include an altitude dimension, the method further comprising:
combining the resource units to cover one or more floors of an office building.

20. The server computing device of claim 11, wherein the processor is configured with processor-executable instructions to perform operations such that offering the resource units for purchase, lease, or trade on a commodities exchange comprises:
grouping the resource units to form a polygon; and
offering the group of resource units for purchase, lease, or trade on the commodities exchange.

21. A non-transitory computer readable storage medium having stored thereon processor-executable software instructions configured to cause a processor of a server computing device to perform operations comprising:
generating granular resource units that each identify an amount of a telecommunication resource that is offered for allocation and use by other networks with respect to an area or volume; and
offering the resource units for purchase, lease, or trade on a commodities exchange.

22. The non-transitory computer readable storage medium of claim 21, wherein the stored processor-executable instructions are configured to cause a processor to perform operations such that generating the granular resource units comprises generating resource units that use a universal standard to identify, quantify, measure, and represent the telecommunication resource.

23. The non-transitory computer readable storage medium of claim 21, wherein the stored processor-executable instructions are configured to cause a processor to perform operations such that generating the granular resource units comprises generating resource units that identify the telecommunication resource in a standardized format and structure.

24. The non-transitory computer readable storage medium of claim 21, wherein the stored processor-executable instructions are configured to cause a processor to perform operations such that generating the granular resource units comprises generating resource units that include a common reference point that is suitable for use in comparing the granular resource units against other resource units.

25. The non-transitory computer readable storage medium of claim 24, wherein the stored processor-executable instructions are configured to cause a processor to perform operations further comprising:
comparing two or more resource units that represent different resource offerings from different networks to determine the relative economic value of the offered amounts of telecommunication resource.

26. The non-transitory computer readable storage medium of claim 21, wherein the stored processor-executable instructions are configured to cause a processor to perform operations such that generating the granular resource units comprises generating resource units that define an amount of bandwidth in relation to a geographic area encompassing one cubic meter.

27. The non-transitory computer readable storage medium of claim 21, wherein the stored processor-executable instructions are configured to cause a processor to perform operations such that generating the granular resource units comprises generating resource units that may be combined to cover a well-defined area.

28. The non-transitory computer readable storage medium of claim 27, wherein the stored processor-executable instructions are configured to cause a processor to perform operations further comprising:
combining the resource units to cover an area that encompasses one of a highway portion, a bridge, a navigation path, a waterway portion, and air traffic corridor.

29. The non-transitory computer readable storage medium of claim 27, wherein the stored processor-executable instructions are configured to cause a processor to perform operations such that the resource units are resource cubes that include an altitude dimension, the method further comprising:
combining the resource units to cover one or more floors of an office building.

30. The non-transitory computer readable storage medium of claim 21, wherein the stored processor-executable instructions are configured to cause a processor to perform operations such that offering the resource units for purchase, lease, or trade on a commodities exchange comprises:
grouping the resource units to form a polygon; and
offering the group of resource units for purchase, lease, or trade on the commodities exchange.
